(19) United States
(12) Patent Application Publication
(10) Pub. No.: US 2026/0289276 A1
(43) Pub. Date: Sep. 24, 2026

(54) SYSTEM

(71) Applicant: SoftBank Group Corp., Tokyo (JP)

(72) Inventor: Hitoshi TAKAGIWA, Tokyo (JP)

(73) Assignee: SoftBank Group Corp., Tokyo (JP)

(21) Appl. No.: 19/567,352

(22) Filed: Mar. 16, 2026

(30) Foreign Application Priority Data
Mar. 19, 2025 (JP) 2025-045275

(51) Int. Cl. G06N 3/0475; G06V 40/16; G10L 25/63

(52) U.S. Cl. CPC G06N 3/0475; G06V 40/176; G10L 25/63

(57) ABSTRACT

A system includes a processor that is configured to generate, by using a generative AI model, a first prompt for setting a goal for each grade in accordance with a department theme, and generate the goal based on the first prompt, generate, by using the generative AI model, a second prompt based on input achievement information, and perform a primary determination of an achievement level based on the second prompt, and analyze, by using an emotion analysis engine, voice or facial expressions of a user to recognize an emotion of the user, and supplement the determination of the achievement level based on the recognized emotion.

### CROSS-REFERENCE TO RELATED APPLICATION

This application is based on and claims priority under 35 USC 119 from Japanese Patent Application No. 2025-045275 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional personnel evaluation systems and goal management systems typically rely on manually set goals, simple numerical comparisons between target values and achieved values, and subjective human judgment by managers. In such systems, goals are often not optimized for each grade or department theme, which leads to inconsistencies in difficulty level and fairness among employees. Furthermore, primary determination of achievement levels is frequently based only on self-reported achievement information or quantitative performance indicators, without sufficient support from intelligent analysis. As a result, the determinations may lack objectivity and adaptability to individual circumstances. In addition, conventional systems rarely incorporate a user's emotional state into the evaluation process. The emotional state of the user, such as motivation, frustration, or stress, is often expressed through voice or facial expressions, but conventional systems fail to systematically analyze such emotional information. Consequently, the obtained evaluations cannot fully reflect the user's situation, and it is difficult to provide nuanced feedback or supportive measures based on the user's emotional condition.

Moreover, secondary determinations, which are supposed to refine the initial evaluation, are typically conducted as manual reviews by supervisors or human resources personnel, and are not consistently supported by standardized AI-based reasoning. This can lead to variations in evaluation quality and increased workload for evaluators. Additionally, even when numerical results of achievement determinations are available, they are not always presented in a visually intuitive format, making it difficult for individuals to quickly understand their own performance and to plan improvements for the next evaluation period.

Therefore, there is a need for a system that can: (i) automatically generate appropriate goals for each grade in accordance with department themes by using a generative AI model; (ii) perform a primary determination of achievement levels based on prompts generated from achievement information by the generative AI model; (iii) recognize and analyze a user's emotional state via an emotion analysis engine and use this to supplement the determination of the achievement level; (iv) conduct a secondary determination using the generative AI model based on the primary determination result; and (v) visually present the determination results in a graph or chart so that an individual can intuitively grasp the evaluation outcome.

### SUMMARY

In order to solve the above-described problems, a system according to one aspect of the present invention comprises a processor, wherein the processor is configured to generate, by using a generative AI model, a first prompt for setting a goal for each grade in accordance with a department theme, and to generate the goal based on the first prompt. In particular, the processor acquires information representing a department theme and a grade of a user, inputs the information into the generative AI model as part of the first prompt, and obtains, from the generative AI model, text and numerical data indicative of a recommended goal. The processor then registers the generated goal in association with the user and the relevant evaluation period.

The processor is further configured to generate, by using the generative AI model, a second prompt based on input achievement information, and to perform a primary determination of an achievement level based on the second prompt. Specifically, when achievement information is input by the user, the processor incorporates the achievement information, and optionally the previously generated goal, into the second prompt, and inputs the second prompt into the generative AI model. The generative AI model outputs text and/or numerical values indicating a primary determination of the achievement level, and the processor calculates or directly adopts an achievement level, such as a percentage, based on the output.

The processor is also configured to analyze, by using an emotion analysis engine, voice or facial expressions of the user to recognize an emotion of the user, and to supplement the determination of the achievement level based on the recognized emotion. In particular, the processor acquires audio data and/or image data including the user's voice or facial expressions, inputs the data into the emotion analysis engine, and obtains an estimated emotional state such as positive, neutral, or negative, and its intensity. The processor then adjusts, annotates, or supplements the primary determination result using the recognized emotion, for example, by modifying evaluation comments, generating supportive feedback, or flagging cases that require human review, thereby enabling a more context-aware determination of the achievement level.

In some embodiments, the processor is further configured to generate, by using the generative AI model, a third prompt for performing a secondary determination based on a result of the primary determination of the achievement level, and to perform the secondary determination based on the third prompt. The processor incorporates the primary determination result, the recognized emotional state, historical performance information, or other relevant data into the third prompt, and inputs the third prompt into the generative AI model. The generative AI model then outputs refined evaluation content, such as adjusted achievement levels, detailed evaluation comments, or recommendations, and the processor records this output as a secondary determination result.

Furthermore, in order to allow an individual to intuitively understand the evaluation result, the processor is configured to use an information display device to display a result of the determination of the achievement level as a graph or chart so that an individual can understand the result at a glance. The processor generates visualization data representing the determination result, including numerical achievement levels and categorical evaluations, and controls the information display device to render such data as gauges, bar charts, line charts, or other graphical formats. As a result, the user can quickly grasp their own evaluation status and readily use the displayed information for self-reflection and planning of future actions. By means of these configurations, the system according to the present invention can automatically generate grade-appropriate goals based on department themes, objectively and flexibly determine achievement levels by utilizing a generative AI model, supplement those determinations with emotion analysis based on the user's voice and facial expressions, refine the evaluations through a secondary determination process using the generative AI model, and present the results in an intuitive visual format. Consequently, the problems of inconsistent goal-setting, insufficient consideration of individual emotional states, heavy burden on human evaluators, and low visibility of evaluation results can be effectively mitigated.

The term “system” refers to an arrangement of one or more hardware devices and software components that cooperate to execute the processing described in the claims, including goal generation, achievement determination, emotion analysis, secondary determination, and result display.

The term “processor” refers to one or more hardware processing units, such as a central processing unit (CPU), a graphics processing unit (GPU), a microprocessor, or a combination thereof, configured to execute instructions that implement the functions recited in the claims.

The term “generative AI model” refers to a machine learning model, such as a large language model or other generative model, that generates text, numerical data, or other outputs in response to input prompts, and that is used to generate goals, determinations, and related content as described in the claims.

The term “prompt” refers to input data, including text, numerical parameters, or structured information, that is supplied to a generative AI model in order to cause the generative AI model to generate a corresponding output such as a goal or a determination result.

The term “department theme” refers to a topic, objective, or area of focus defined for a particular department or organizational unit, such as sales growth, quality improvement, or customer satisfaction, which serves as a basis for setting goals.

The term “grade” refers to a classification or level assigned to a user within an organization, such as a job rank, seniority level, or position category, and is used to differentiate goals or evaluations among users.

The term “goal” refers to a target or objective associated with a user, a department theme, and a grade, including at least one numerical target value and optionally a textual description, that is generated based on output from the generative AI model.

The term “achievement information” refers to data input by or on behalf of a user that indicates the extent to which the user has realized or attempted to realize a goal, and may include numerical performance values, textual descriptions, or other evidence of performance.

The term “primary determination” refers to an initial evaluation or judgment of an achievement level for a goal, calculated or derived based on a prompt generated from achievement information and processed by the generative AI model.

The term “achievement level” refers to a quantitative or qualitative measure indicating how much a user's actual achievement satisfies or corresponds to a goal, and may be expressed as a percentage, score, rating, or categorical indicator.

The term “emotion analysis engine” refers to a software component or combination of software and hardware configured to analyze user input data such as voice signals or images of facial expressions, and to estimate or classify the emotional state of the user.

The term “voice” refers to audio data representing spoken sounds produced by a user, including speech content, tone, pitch, and other acoustic features suitable for emotion analysis.

The term “facial expressions” refers to visual features of a user's face, such as movements or configurations of facial muscles, that are detectable from image or video data and can be analyzed to infer an emotional state.

The term “emotion” refers to a psychological or affective state of a user, such as happiness, anger, sadness, stress, or neutrality, including at least a type of emotion and optionally its intensity, recognized by the emotion analysis engine.

The term “supplement the determination” refers to modifying, annotating, or augmenting a determination of an achievement level, for example by adjusting scores, generating additional comments, or triggering flags, based at least in part on recognized emotional information.

The term “secondary determination” refers to a subsequent evaluation or refinement of an achievement level that is performed after the primary determination, based on a prompt that includes the primary determination result and optionally other related information, and processed by the generative AI model.

The term “information display device” refers to any hardware device capable of visually presenting information to a user, such as a monitor, display panel, tablet screen, smartphone screen, or projector, when controlled by the processor.

The term “graph or chart” refers to a visual representation of data related to an achievement level, including but not limited to bar graphs, line graphs, pie charts, gauge charts, radar charts, and similar graphical formats that express numerical or categorical information.

The term “result of the determination of the achievement level” refers to the outcome of the primary determination, the secondary determination, or a combination thereof, including numerical values, categorical evaluations, and associated explanatory information, which is presented to a user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

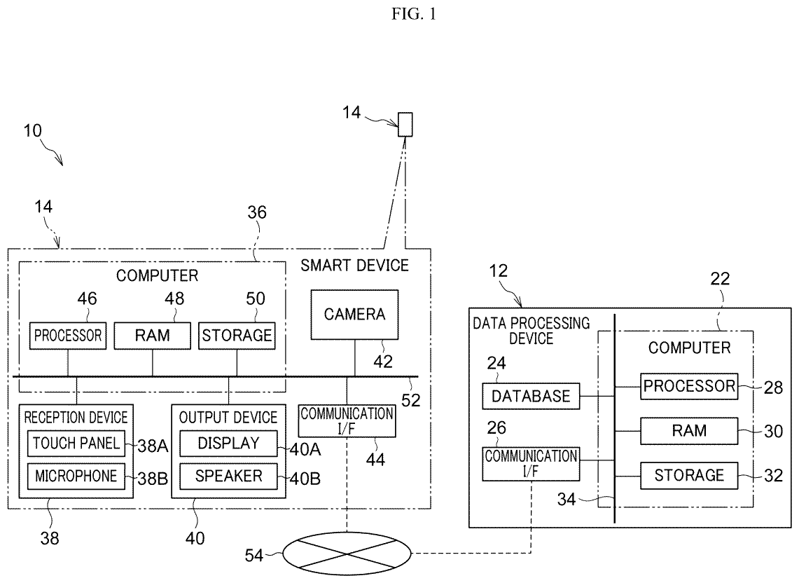

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

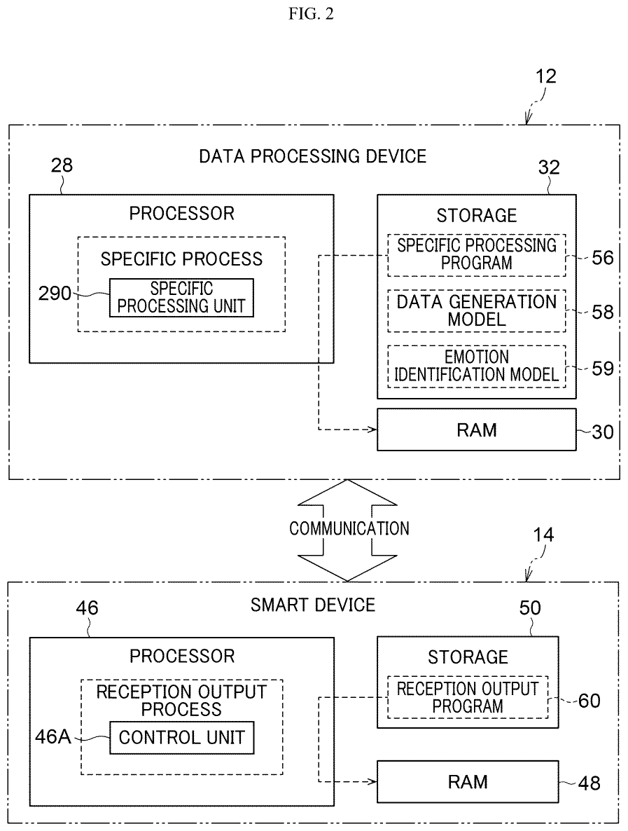

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional goal-setting and performance-evaluation systems for organizations typically rely on static rule engines, manually designed templates, and ad hoc human judgment. In such systems, a processor often executes simple threshold comparisons or fixed formulae over stored numerical records and then presents the resulting scores on a display. These approaches suffer from several limitations from the standpoint of computer technology.

First, conventional systems are not architected to automatically adapt their internal models as organizational data accumulates. Even when historical goal-setting information and performance information are stored, the processor generally applies identical, static rules to all future cases. As a result, the system does not exploit the available data to improve the quality of generated goals or the accuracy of performance evaluation, and the computational resources devoted to storing and maintaining large historical datasets are underutilized.

Second, known systems typically separate numerical computation from natural-language interaction. A processor may compute a numerical target value but rely on manual editing or simple template substitution to generate a natural-language goal sentence. This separation leads to a fragmented processing pipeline in which structured outputs from a prediction component are not tightly integrated with a language-generation component. The system cannot flexibly generate context-dependent, personalized goal sentences that reflect both model predictions and user-provided context such as a prompt sentence, and it cannot systematically reuse those sentences and related metadata to refine later computations.

Third, emotion information derived from multimodal user input, such as voice information and facial information, is usually not integrated into the core evaluation pipeline as machine-usable features. Conventional systems that recognize user sentiment often treat emotion classification as an endpoint (for example, merely displaying a sentiment label), rather than as an input to the main evaluation logic. Consequently, the processor does not use emotion-related information to complement or modulate a primary evaluation result computed from achievement content, and therefore cannot produce a richer, context-aware evaluation signal that can be fed back into learning procedures.

Fourth, visualization of performance information is commonly implemented as a simple rendering layer, in which the processor merely forwards precomputed scores to a charting component. Time-series relationships, hierarchy-based comparisons, and correlations between goals and achievement evaluations are often not explicitly encoded as structured visualization data generated at the processing level. As a result, the system cannot systematically generate or reuse such visualization data as part of its internal data structures for subsequent learning, and the display logic remains loosely coupled with the underlying evaluation computations.

Overall, conventional systems fail to provide an integrated technical architecture wherein (i) machine learning models calculate structured target values from historical information, (ii) a generative AI model receives prompt sentences constructed from those structured values and other context to generate natural-language goal sentences, (iii) emotion analysis results and evaluation results are jointly accumulated as historical information, and (iv) the accumulated information is programmatically reused for relearning or parameter adjustment of both the machine learning model and the generative AI model. This fragmentation leads to suboptimal utilization of memory, processing, and model-inference resources, and prevents the system from continuously improving its automated behavior over time in a computer-implemented, closed-loop manner.

Accordingly, there is a need for a computer-implemented system and processing architecture in which a processor systematically acquires organizational theme information and organizational hierarchy information, processes historical goal and performance information with a machine learning model to compute structured target values, constructs prompt sentences for a generative AI model to output natural-language goal sentences, integrates emotion analysis into an automated primary and secondary evaluation pipeline, generates structured visualization data, and accumulates all such information in a form that enables continuous relearning and parameter adjustment. Such a system would improve the functioning of the computer by enabling adaptive, data-driven goal generation and evaluation processes that are tightly integrated across numerical prediction, natural-language generation, multimodal emotion analysis, and visualization layers.

The specific processing by the specific processing unit 290 of the data processing device 12 in Example 1 is realized by the following means.

The present invention provides a server comprising a processor and a memory storing instructions that, when executed by the processor, cause the processor to acquire organizational theme information and organizational hierarchy information, obtain historical information including past goal-setting information and past performance information from a storage device, extract feature information from the historical information, and calculate structured target values by using a machine learning model based on the feature information so as to automatically set a plurality of hierarchy-specific goals in accordance with the organizational theme information and the organizational hierarchy information; to generate a first prompt sentence for input to a generative AI model based on the structured target values, the organizational theme information, and the organizational hierarchy information, and to input the first prompt sentence to the generative AI model so as to generate a goal sentence expressed in natural language; to store the organizational theme information, the organizational hierarchy information, the historical information, and the structured target values in association with the goal sentence expressed in natural language in the storage device such that the stored information is available for subsequent learning processing and evaluation processing; to generate a second prompt sentence for input to the generative AI model based on achievement content acquired from an input device, and to perform primary evaluation of a degree of achievement of the achievement content based on an output of the generative AI model responsive to the second prompt sentence; to acquire user voice information and user facial information, analyze the user voice information and the user facial information by using an emotion analysis engine to extract user emotion information, and perform an achievement evaluation by complementing a primary evaluation result for the achievement content based on the user emotion information; to visually display an achievement evaluation result and the goal sentence expressed in natural language via a display device so as to present the achievement evaluation result and the goal sentence in a manner that enables an individual to integrally grasp a goal and an achievement status; to accumulate the achievement evaluation result and the user emotion information as historical information in the storage device; and to perform relearning or parameter adjustment for the machine learning model and for the generative AI model by using the accumulated historical information so as to continuously improve accuracy of subsequent goal generation and subsequent achievement evaluation. This enables an integrated computer-implemented processing pipeline in which numerical prediction, prompt construction, natural-language generation, multimodal emotion analysis, evaluation computation, and visualization are tightly coupled, thereby improving utilization of stored historical information, enhancing adaptability and precision of automatically generated goals and evaluations over time, and improving the overall technical performance of the goal-setting and performance-evaluation system.

The term “organizational theme information” refers to information indicating an overall objective, policy, or focus area defined for an organization or a subdivision thereof, such as a department-level or company-wide target to be achieved within a predetermined period.

The term “organizational hierarchy information” refers to information indicating a structural level or rank within an organization, including but not limited to roles, grades, positions, or tiers, used to distinguish different responsibility levels among members of the organization.

The term “historical information” refers to information accumulated over time in a storage device, including past goal-setting information, past performance information, past achievement evaluation results, user feedback, and user emotion information related to goal achievement.

The term “goal-setting information” refers to information representing previously defined goals or targets for individuals or groups within an organization, including associated metrics, time frames, required levels of performance, and contextual attributes.

The term “performance information” refers to information representing actual results or outcomes produced by individuals or groups within an organization relative to predefined metrics or indicators, such as numerical measures of sales, productivity, quality, or other key performance indicators.

The term “feature information” refers to information derived from raw data by preprocessing and transformation operations, including numerical, categorical, and encoded textual attributes, that is suitable for input to a machine learning model for training or inference.

The term “structured target values” refers to values represented in a machine-readable structured format that specify one or more quantitative or categorical aspects of a recommended goal, such as a target metric, a target change amount or rate, a time period, and a difficulty level.

The term “machine learning model” refers to a computational model that has been trained on data to learn patterns or relationships, and that, when executed by a processor, receives feature information as input and produces predictions, classifications, or other inferred values such as structured target values.

The term “generative AI model” refers to an artificial intelligence model configured to generate output data, such as natural-language text, in response to input data, and typically implemented as a large-scale neural network that produces sequences of tokens based on a received prompt sentence.

The term “prompt sentence” refers to one or more machine-readable textual expressions composed according to a predefined format and provided as input to a generative AI model so as to condition or guide the behavior of the generative AI model when generating an output.

The term “goal sentence expressed in natural language” refers to a sentence or text fragment represented in a human-readable natural language, generated by a generative AI model or another text-generation component, that describes a goal or target in a form suitable for presentation to a user.

The term “achievement content” refers to information indicating actual outcomes, activities, or results submitted by a user or obtained from a system, which are to be evaluated against a corresponding goal, and which may include numerical data, textual descriptions, or other records.

The term “degree of achievement” refers to an evaluation value or category that represents how closely the achievement content matches or satisfies a corresponding goal, and may include quantitative scores, qualitative labels, or combined indicators.

The term “primary evaluation” refers to an initial evaluation process performed by a processor on achievement content, typically based on at least one model output or rule set, before any modification or supplementation using additional contextual information such as user emotion information.

The term “secondary evaluation” refers to an additional evaluation process performed after the primary evaluation, in which the processor may use further information, such as refined prompts to a generative AI model or aggregated contextual data, to generate an updated or more detailed evaluation result.

The term “emotion analysis engine” refers to a software or hardware-implemented component that analyzes input data such as voice information, facial information, or other behavioral signals, and outputs user emotion information such as emotional categories, intensities, or valence indicators.

The term “user voice information” refers to audio information representing a user's spoken utterances, vocal tone, or acoustic characteristics, acquired by a microphone or similar device and used as input for emotion analysis or related processing.

The term “user facial information” refers to image or video information representing a user's facial expressions, movements, or features, acquired by an imaging device and used as input for emotion analysis or related processing.

The term “user emotion information” refers to information derived from emotion analysis, such as emotion labels, scores, or distributions, representing one or more emotional states of a user, and used by a processor as input for evaluation or decision-making processes.

The term “achievement evaluation result” refers to an output of an evaluation process, including at least a representation of the degree of achievement of a goal by corresponding achievement content, and optionally including associated metadata such as confidence values or reasoning indicators.

The term “information storage device” refers to any memory or storage medium, including volatile memory and non-volatile memory, that stores information such as organizational theme information, organizational hierarchy information, historical information, structured target values, goal sentences, and evaluation results in a machine-readable form.

The term “display device” refers to an output device, such as a monitor, screen, or other visual interface, configured to present information, including textual, graphical, and chart-based content, to a user.

The term “visualization data” refers to structured data prepared for graphical presentation, including time-series information, achievement-rate information, hierarchy-comparison information, and other visualization parameters, which can be rendered as graphs, charts, or similar visual forms.

The term “time-series information” refers to information that associates values of one or more variables with corresponding time points or time intervals, enabling temporal analysis or visualization of changes over time.

The term “achievement-rate information” refers to information indicating ratios or percentages that express how much of a goal has been achieved relative to a target value, including partial or cumulative achievement measures.

The term “hierarchy-comparison information” refers to information enabling comparison of goals, performance, or evaluation results across multiple organizational hierarchy levels or categories, such as comparisons between different grades, positions, or units.

The term “relearning” refers to a process in which a machine learning model is trained again or further trained on updated or augmented datasets that include newly accumulated historical information, thereby updating model parameters to reflect new patterns or corrections.

The term “parameter adjustment” refers to a process of modifying one or more parameters of a machine learning model or a generative AI model, including but not limited to model weights, hyperparameters, prompt-construction rules, or scoring thresholds, to alter model behavior or improve model performance.

The term “integrated processing pipeline” refers to a sequence of programmatically linked processing stages, including numerical prediction, prompt construction, natural-language generation, emotion analysis, evaluation computation, and visualization data generation, orchestrated by a processor so that outputs of preceding stages are systematically used as inputs to subsequent stages.

In one embodiment, a server executes a goal-setting and performance-evaluation system using a processor, a main memory, a non-volatile storage device, and a network interface operating under an operating system such as a general-purpose server operating system. The server communicates with at least one terminal via a communication network such as the Internet or a local area network. The terminal includes, for example, a smartphone, tablet, or personal computer equipped with a display device, an audio input device, an image capture device, and an input interface, and executes a web browser or dedicated application program.

The server stores in the storage device a plurality of software modules, including a web application module, a data management module, a feature extraction module, a machine learning inference module, a generative AI interaction module, an emotion analysis module, an evaluation computation module, and a visualization module. The server loads these modules into the main memory and executes them with the processor.

The server uses a relational database management system executed on the storage device to manage organizational theme information, organizational hierarchy information, historical information, structured target values, goal sentences, achievement content, and evaluation results. The server represents each item of organizational theme information and each item of organizational hierarchy information as a record in a normalized table structure, such as a theme table and a hierarchy table, each having identifiers, text attributes, and categorical attributes. The server represents historical information as a collection of linked records, including goal-setting records, performance records, evaluation records, and emotion records, interconnected by foreign keys.

The server implements the machine learning inference module using a machine learning framework such as a numerical computation and neural network library. The server stores parameters of a trained neural network model in a model file in the storage device. In one embodiment, the server uses a deep neural network that combines a text-encoding subnetwork and a dense prediction subnetwork. The server configures the text-encoding subnetwork as a multi-layer architecture including an embedding layer that converts tokenized theme text and prompt text into dense vectors, followed by one or more recurrent layers or transformer-based self-attention layers that compute contextualized representations of the text. The server configures the dense prediction subnetwork as a stack of fully connected layers with nonlinear activation functions, such as rectified linear units, and an output layer that produces structured target values including at least one target metric, a target change rate, and a time frame.

The server obtains training data for the neural network model from historical information. The server constructs input feature vectors by combining encoded theme text, encoded hierarchy category, aggregated performance statistics, and, optionally, user feedback information. The server computes a loss function such as a mean squared error between predicted target change rates and historically effective change rates, optionally combined with a regularization term such as an L2 regularization term. The server updates model weights using an iterative optimization algorithm such as stochastic gradient descent or an adaptive gradient method, using mini-batches of training samples. The server repeats weight updates until a convergence criterion or a maximum number of training epochs is satisfied, and stores the trained model.

The server receives, from the terminal, organizational theme information and organizational hierarchy information as text strings entered by a user. The user uses the terminal to access a web page or application screen that provides input fields labeled with descriptions such as “Theme” and “Hierarchy Level.” The user may further input a prompt sentence that specifies additional constraints or instructions for goal generation. For example, the user may input a prompt sentence such as:

“Set a realistic but challenging sales goal for the next quarter for mid-level employees in the Sales Department.”

The terminal sends the inputted theme, hierarchy, and prompt sentence to the server via a secure communication protocol. The server validates the received strings, normalizes them by operations such as case conversion and whitespace trimming, and stores them in the relational database as new records or updates to existing records.

The server uses the feature extraction module to convert the normalized theme and hierarchy into machine-readable feature information. The server tokenizes the text strings corresponding to the theme and the prompt sentence by splitting them into tokens based on a predefined vocabulary. The server maps each token to an integer index using a token dictionary, and converts the sequence of indices into an embedding matrix by using a learned embedding table. The server computes additional numerical features such as averages and variances of past performance metrics associated with the same theme or hierarchy by executing aggregation queries over the historical performance table. The server concatenates text-based embeddings and numerical features into a fixed-dimension feature vector.

The server inputs the feature vector into the machine learning model stored in memory, and the processor executes a series of matrix multiplications, bias additions, and nonlinear activations defined by the neural network layers. The server thereby calculates structured target values indicating, for example, a recommended percentage change in a performance metric, a time period such as “next quarter,” and a difficulty level such as “medium.”

The server then uses the generative AI interaction module to construct a prompt sentence for a generative AI model based on the structured target values, the organizational theme information, the organizational hierarchy information, and any user-provided prompt sentence. The server constructs the prompt sentence as a textual instruction that embeds structured values in natural language form. For example, the server may construct a prompt sentence such as:

“You are an assistant that creates performance goals. Organization theme: sales department revenue improvement. Employee hierarchy: mid-level employee. Recommended quantitative target: increase revenue by 10% in the next quarter. Conditions: The goal must be measurable, time-bound, and realistic. Generate one clear goal sentence.”

The server sends the constructed prompt sentence to a remote or local generative AI model via a network interface using an application programming interface. The generative AI model comprises a transformer-based neural network with multiple layers of self-attention and feed-forward sublayers, and internally maintains learned parameters representing token embeddings, positional encodings, attention weights, and feed-forward weights. The generative AI model receives the prompt sentence as a sequence of tokens, computes attention scores across the sequence, and predicts a sequence of output tokens representing the goal sentence. The server receives the generated sequence from the generative AI model and decodes it into a natural-language string.

The server performs rule-based postprocessing on the generated goal sentence. The server applies pattern-matching operations to ensure that the sentence includes at least one quantitative target, a time reference, and a performance metric. The server may enforce constraints such as disallowing negative growth where not permitted by business rules. If a constraint is violated, the server may modify the prompt sentence to include additional instructions and request a revised generation from the generative AI model.

The server associates the natural-language goal sentence with the structured target values, the organizational theme information, the organizational hierarchy information, and the historical information used to generate the goal. The server stores this association as linked records in the relational database. By doing so, the server constructs a data structure that couples numerical targets, textual descriptions, and context information in a machine-readable form. This integrated data structure supports subsequent learning and evaluation operations.

The user later uses the terminal to input achievement content corresponding to the generated goal. The user may enter numerical values such as actual sales numbers and textual descriptions such as “Successfully acquired three new clients.” The terminal sends the achievement content to the server. The server stores the achievement content and generates a new prompt sentence for the generative AI model to perform primary evaluation. The server composes this prompt sentence by embedding the goal sentence and the achievement content into an instruction, such as:

“Given the following goal: ‘The mid-level sales employee shall increase total quarterly revenue by 10% compared to the previous quarter while maintaining at least a 4.3 out of 5 customer satisfaction score.’ And the following achievement report: ‘The employee increased revenue by 9% and maintained an average satisfaction score of 4.5.’ Provide a concise evaluation of the degree of achievement in one sentence and classify it as fully achieved, mostly achieved, partially achieved, or not achieved.”

The server sends this prompt sentence to the generative AI model, receives produced evaluation text and possibly an indicated category, and maps the category to a numerical evaluation score. The server thereby obtains a primary evaluation result. By using a consistent, machine-readable classification scheme, the server is able to treat the generative output as structured evaluation information rather than unstructured text.

The server further uses the emotion analysis module to complement the primary evaluation. The terminal captures user voice information and user facial information when the user reviews the goal and its evaluation on the display device. The terminal sends audio and image data to the server, or in another embodiment, processes them locally and sends extracted features. The server applies the emotion analysis engine, which can be implemented as one or more convolutional neural networks and recurrent or transformer layers trained on labeled emotion datasets, to the voice information and facial information. The server extracts user emotion information such as categories (e.g., satisfied, frustrated) and intensities. The server then combines the primary evaluation result and the emotion information according to predefined rules or a trained fusion model, thereby adjusting the evaluation output when a discrepancy between objective achievement and user emotion is detected.

The server provides the final evaluation result and the goal sentence to the visualization module. The server generates visualization data structures that encode, for each user and hierarchy, time-series trends of goals and evaluations, achievement rates, and hierarchy-level comparisons. The server stores these visualization data structures and sends them to the terminal. The terminal renders graphs or charts on the display device using a drawing library, enabling the user to view their relative position within the organizational hierarchy and temporal evolution of their performance. This structured generation of visualization data, rather than a simple rendering of raw values, enables the server to reuse visualization data for further analytical tasks and model training.

The server continually accumulates historical information including generated goal sentences, structured target values, primary and secondary evaluation results, emotion information, and visualization-derived indicators. The server periodically performs relearning or parameter adjustment of the machine learning model and, in some embodiments, adjustment of prompt-construction rules for the generative AI model. The server retrieves stored records, constructs updated training datasets, recalculates loss functions that take into account not only deviations between predicted targets and actual performance results but also discrepancies between evaluation outputs and subsequent emotion-based corrections, and updates model weights. This closed-loop process enables the server to improve prediction accuracy and evaluation consistency over time in a way that a static rules-based system cannot.

The server thereby improves computer technology in several respects. The server reduces computational waste by constructing and storing integrated data structures that link numerical, textual, and emotional features, making subsequent learning and inference more efficient. The server improves processing speed and scalability because the machine learning inference on compact feature vectors replaces repeated human-designed rule execution and manual data editing. The server improves evaluation accuracy by incorporating multimodal emotion features and generative evaluation outputs into a fused, structured representation that can be quantitatively optimized. The server optimizes communication load by transmitting compact feature representations or identifiers instead of repeatedly transmitting full historical datasets between components. The server also improves memory utilization by normalizing and reusing feature and visualization data across multiple goals and evaluation cycles.

The system does not merely automate human reasoning; rather, the server applies specific, non-conventional processing flows that exploit the capacity of neural network architectures and generative models to construct prompt sentences, structured target values, and evaluation results in a closed feedback loop. The server performs operations, such as embedding-based feature extraction, transformer-based text encoding, gradient-based weight updating with explicit loss functions, and structured visualization data generation, that are not naturally carried out by human agents without specialized computing resources. These technical operations collectively enhance the functioning of the computer system itself by systematically converting heterogeneous inputs into unified, learnable representations and by reusing those representations to improve subsequent computation.

Alternative embodiments are also possible. The server may use different neural network architectures, such as convolutional networks for text character-level encoding, or may replace a deep neural network with a gradient boosting machine or other non-linear model for generating structured target values, while still constructing prompt sentences and accumulating historical information as described. The terminal may perform part of the feature extraction or emotion analysis locally and send intermediate features to the server to reduce communication bandwidth. The server may adjust the structure of prompt sentences based on dynamic templates selected from a template database, allowing fine-grained control over the interaction with different generative AI models. In each embodiment, the essential characteristic remains that the server orchestrates an integrated pipeline that couples machine learning prediction, generative AI prompt construction and response processing, multimodal emotion analysis, evaluation computation, and visualization data generation in a manner that improves the technical performance of the goal-setting and performance-evaluation system.

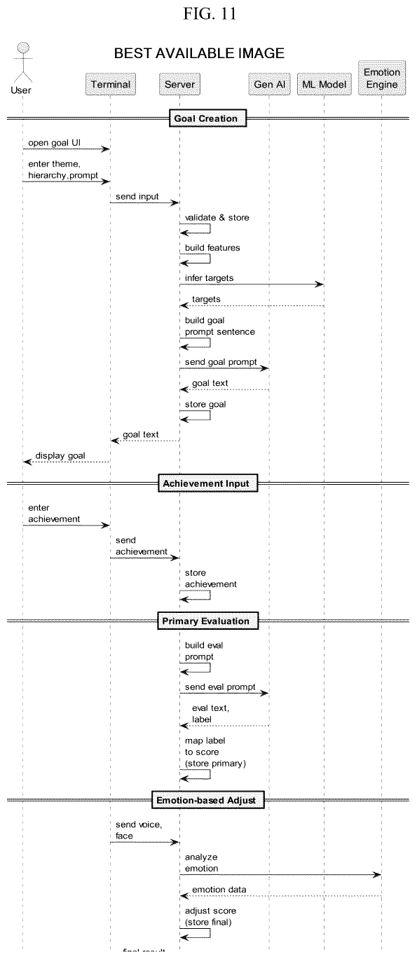

The following describes the processing flow using FIG. 11.

### Step 1:

User operates the terminal to access a goal-setting screen provided by the server.

User inputs organizational theme information, organizational hierarchy information, and optionally a free-form prompt sentence into input fields displayed on the terminal.

Terminal receives these text strings as input and temporarily stores them in a local memory structure associated with the display components.

Terminal sends the input data to the server as a structured request via a network connection.

The terminal converts the text fields into a request payload and transmits the payload using a communication protocol.

### Step 2:

Server receives the request payload from the terminal as input and parses the organizational theme information, the organizational hierarchy information, and the optional prompt sentence.

Server validates each field by checking for missing values, forbidden characters, and maximum lengths, and normalizes text by converting character cases, trimming whitespace, and applying synonym mappings.

Server performs data conversion operations to map the organizational hierarchy information to an internal hierarchy identifier, and outputs a normalized and structured representation of the user input.

Server stores the normalized data as records in a database with unique identifiers to be used as input in subsequent processing.

### Step 3:

Server uses the organizational theme information and the organizational hierarchy information as input keys to query the database for historical information including past goal-setting information and past performance information.

Server executes aggregation operations, such as calculating averages, variances, and trend indicators over performance metrics associated with the same theme and hierarchy.

Server performs data processing to construct a historical feature record that summarizes relevant past behavior, and outputs this record as an intermediate dataset.

Server stores or caches the historical feature record in memory for immediate use by the feature extraction module.

### Step 4:

Server takes as input the normalized text strings (theme, hierarchy, optional prompt sentence) and the historical feature record.

Server performs tokenization on the text strings by splitting them into tokens and mapping each token to a numerical index using a vocabulary table.

Server applies an embedding operation that converts token indices into dense vectors using an embedding matrix, and combines these vectors with the numerical elements from the historical feature record.

Server outputs a fixed-length feature vector representing the combined context of theme, hierarchy, and historical performance, and passes this feature vector to the machine learning inference module.

### Step 5:

Server inputs the feature vector into a machine learning model stored in memory.

Server performs numerical computations defined by the model architecture, including matrix multiplications, additions of bias terms, and activation functions across multiple layers of the model.

Server calculates structured target values such as a target metric identifier, a target change rate, a time period, and a difficulty label based on the processed feature vector.

Server outputs the structured target values as a machine-readable record and stores them in association with the original input identifiers.

### Step 6:

Server uses as input the structured target values, the organizational theme information, the organizational hierarchy information, and the optional user-provided prompt sentence.

Server constructs a prompt sentence by concatenating these inputs into a formatted natural-language instruction that embeds the structured target values into descriptive text.

Server performs string assembly operations, such as inserting numerical values into predefined template segments and appending constraints or style guidelines.

Server outputs a completed prompt sentence that is suitable for input to a generative AI model.

### Step 7:

Server sends the constructed prompt sentence as input to a generative AI model via a model interface.

Server receives a sequence of output tokens produced by the generative AI model in response to the prompt sentence, and decodes these tokens into a natural-language goal sentence.

Server performs postprocessing operations, such as checking for the presence of numerical targets, time references, and metric names, and may adjust or regenerate the prompt if required conditions are not met.

Server outputs a finalized goal sentence expressed in natural language and stores the sentence in a database linked to the structured target values and user context.

### Step 8:

Server combines the organizational theme information, the organizational hierarchy information, the historical information, the structured target values, and the finalized goal sentence as input to the data management module.

Server writes these combined data elements into related database tables using insertion and update operations, maintaining foreign-key relationships to preserve associations.

Server performs indexing and metadata generation to optimize retrieval of these records for future learning and evaluation processes.

Server outputs a persistent, integrated data structure that can be referenced by identifier in later processing stages.

### Step 9:

Server sends the finalized goal sentence and related structured target values as output data to the terminal.

Terminal receives the goal data as input, parses the fields, and binds them to display components on the screen.

Terminal performs rendering operations using its display engine to show the goal sentence in text form and, optionally, to show numerical targets in labeled areas.

User views the displayed goal sentence and internalizes or records the proposed target for future action.

### Step 10:

User later operates the terminal to input achievement content that describes actual results in relation to the displayed goal.

User provides numerical values, textual descriptions, or both, indicating the degree to which the goal has been pursued or accomplished.

Terminal receives this achievement content as input, converts it into structured fields, and sends it to the server as an achievement-report request.

Server stores the received achievement content in the database for use in evaluation processing.

### Step 11:

Server takes as input the stored goal sentence and the newly received achievement content.

Server constructs a new prompt sentence that embeds both the goal sentence and the achievement content, along with explicit instructions for evaluation categories.

Server performs string operations to combine these elements into a coherent evaluation-oriented instruction and outputs this evaluation prompt sentence.

Server inputs the evaluation prompt sentence to the generative AI model and receives an evaluation text output and, optionally, a classification tag indicating the degree of achievement.

### Step 12:

Server parses the evaluation text and classification tag received from the generative AI model as input.

Server maps the classification tag, such as “fully achieved” or “partially achieved,” to a numerical evaluation score using a predefined mapping table.

Server creates a primary evaluation record that includes the numerical score, the classification tag, and the evaluation text, and stores this record in the database.

Server outputs the primary evaluation result as structured data to be used in subsequent emotion-based adjustment processing.

### Step 13:

Terminal captures user voice information and user facial information while the user is reviewing the evaluation result on the display device.

Terminal uses its microphone and camera to obtain audio signals and image frames as input, and sends these raw or preprocessed signals to the server.

Server receives the audio and image data and inputs them into an emotion analysis engine.

Server executes feature extraction algorithms on the audio and image data, such as spectral analysis for voice and facial landmark detection for images, and outputs user emotion information indicating emotional state categories and intensities.

### Step 14:

Server uses the primary evaluation result and the user emotion information as joint inputs to an evaluation adjustment module.

Server applies rule-based logic or a learned fusion model to compare the numerical primary evaluation with the detected emotional state, for example, increasing the weight of negative emotion when the numerical result is borderline.

Server computes an adjusted evaluation score and may assign a refined category, generating a final achievement evaluation result.

Server stores this final achievement evaluation result in the database and outputs it for visualization and future learning.

### Step 15:

Server retrieves, as input, the final achievement evaluation result, the corresponding goal sentence, and historical evaluation records for the same user and hierarchy.

Server generates visualization data structures encoding time-series trends of evaluation scores, achievement rates, and comparisons across organizational hierarchy levels.

Server formats these data structures into a form suitable for graphical rendering, including axis labels, data points, and grouping indicators, and outputs the visualization data to the terminal.

Terminal receives the visualization data and renders graphs or charts on the display device, allowing the user to visually inspect performance over time and relative to peers.

### Step 16:

Server periodically uses accumulated historical information, including structured target values, achievement content, primary and final evaluation results, and user emotion information, as input to a retraining module.

Server reconstructs training datasets, recalculates loss functions that combine prediction errors and evaluation consistency metrics, and performs weight updates on the machine learning model to refine its parameters.

Server optionally adjusts prompt-construction rules for the generative AI model based on observed discrepancies between generated goal sentences, evaluation reliability, and user emotion patterns.

Server outputs updated model parameters and prompt templates, thereby improving the accuracy and efficiency of subsequent goal generation and achievement evaluation cycles.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional production management and performance evaluation systems rely on static rule sets or manually configured targets that are detached from actual historical production behaviors and operator conditions. In typical implementations, a computer system simply stores user-defined production targets in a database and later compares measured production values against these targets using fixed threshold calculations. Such systems fail to exploit large volumes of past production and quality data in a structured, model-based manner, and they do not integrate flexible natural language reasoning or narrative evaluation into the computational pipeline. As a result, target setting often remains subjective, inconsistent across production lines, and insensitive to differences in department themes and task grades.

Furthermore, in many existing systems, the computing architecture is not optimized to use machine learning models together with generative AI models in a coordinated way. A common server only performs basic arithmetic operations and simple queries, without dynamically generating prompt sentences for a generative AI model based on model predictions, historical data, and user inputs. This leads to a fragmented workflow in which artificial intelligence is used in an ad hoc manner, if at all, rather than being systematically embedded in the core logic of the server. Consequently, the server cannot automatically refine target predictions, cannot generate detailed textual evaluations aligned with numerical judgments, and cannot adapt its behavior based on user-specific contextual information. Additionally, existing performance evaluation tools typically ignore user affective states. Even when voice or image data are collected for communication or monitoring, most systems do not use an emotion analysis engine to estimate a user's emotional state and feed that estimation back into the achievement judgment logic. This omission results in a rigid evaluation process that does not account for operator stress, frustration, or confidence, and it prevents the system from adjusting narrative feedback and improvement suggestions in a way that better supports human users. From a computer technology standpoint, the server is not configured to integrate multimodal analysis pipelines (numerical data, text outputs from a generative AI model, and emotion analysis results) into a unified computational decision process.

Moreover, conventional visualization mechanisms often render simple static charts on client devices, without tightly coupling those visualizations to the underlying AI-generated judgments and narrative evaluations. The server may merely send raw numeric values to a client, leaving the client to perform its own rudimentary plotting with limited interaction. This architecture constrains the scalability and consistency of presentation and prevents the central server from optimizing and standardizing visualization generation based on the same data and models used for target prediction and evaluation.

Accordingly, there is a need for a technical improvement in computer-based production management and evaluation systems. Specifically, there is a need for a server-side architecture that (i) acquires and preprocesses historical production and quality data, (ii) constructs and applies regression or other machine learning models to predict baseline production targets, (iii) dynamically generates prompt sentences for a generative AI model to refine or validate those targets and to create narrative evaluations, (iv) integrates emotion analysis of user voice or image data to adjust achievement judgments, and (v) generates standardized visualization data that can be consistently rendered on terminals. By solving these issues through a coordinated set of computational steps executed by a processor, the invention aims to improve the functioning of the computer system itself, enabling more accurate, context-aware target setting and evaluation, and more effective human-machine interaction in production environments.

The specific processing by the specific processing unit 290 of the data processing device 12 in Application Example 1 is realized by the following means.

The present invention provides a server comprising a processor, a storage device, a communication interface, and a display control mechanism, the processor being configured to execute program code that causes the server to (i) receive, via the communication interface, department theme information and grade information from a terminal operated by a user, and store the information in the storage device; (ii) acquire, from the storage device, past production information and past quality information, preprocess such information by use of data processing software to generate feature data including at least the department theme information and the grade information, and construct or update a regression model by use of statistical learning software so as to predict a baseline production target value for a production line; (iii) generate a first prompt sentence for input to a generative AI model based on the department theme information, the grade information, the past production information, the past quality information, and the baseline production target value, transmit the first prompt sentence to the generative AI model via the communication interface, receive a response from the generative AI model, and correct or approve the baseline production target value based on the response to determine a final production target value and corresponding explanation information; (iv) transmit the final production target value and the explanation information to the terminal for display and receive, via the communication interface, confirmation or approval input from the terminal and store an approval status in the storage device; (v) receive, via the communication interface from the terminal at an end of an evaluation period, achievement production information representing actual production results and comment information representing user comments, compare the achievement production information with the final production target value, calculate at least an achievement rate, and generate a primary achievement judgment result by use of rule-based logic or a machine learning model; (vi) generate a second prompt sentence for input to the generative AI model based on the primary achievement judgment result, the achievement production information, the comment information, and the final production target value, transmit the second prompt sentence to the generative AI model, receive a second response from the generative AI model, and generate textual evaluation information and improvement proposal information based on the second response; (vii) analyze, by use of an emotion analysis engine, voice data or image data of the user acquired via the terminal, estimate an emotion state of the user, and correct at least one of the primary achievement judgment result and the textual evaluation information based on the estimated emotion state; and (viii) generate, by use of visualization software, display data including at least the achievement rate, an achievement judgment result, the textual evaluation information, the improvement proposal information, and graphical or chart-based comparison between the final production target value and the achievement production information, and transmit the display data to the terminal for display on a display device. This enables the computer system to technically improve production target setting and achievement evaluation by tightly integrating machine learning-based prediction, generative AI reasoning through dynamically constructed prompt sentences, multimodal emotion analysis, and server-side visualization generation, thereby enhancing the accuracy, contextual relevance, and user-adaptive behavior of the server's processing while reducing reliance on fixed rules and manual configuration.

The term “processor” refers to a hardware computation unit, such as a central processing unit or a computation core, that executes program code to perform arithmetic operations, logical operations, data transfer operations, and control operations according to instructions stored in a storage device.

The term “storage device” refers to a hardware data retention unit, such as a memory device or a non-volatile storage device, that stores program code, configuration data, historical data, model parameters, prompt sentences, responses from a generative AI model, and intermediate computation results.

The term “communication interface” refers to a hardware and software communication unit, such as a network interface and associated protocol stack, that enables the server to transmit data to and receive data from external devices, including terminals and external AI services, via wired or wireless communication networks.

The term “display device” refers to a hardware presentation unit, such as a monitor, a touch panel, or a screen of a smart device, that visually presents information including numerical values, text, graphs, and charts to a user.

The term “terminal” refers to an external information processing apparatus, such as a client device or a smart device, that communicates with the server via the communication interface, presents information to the user on the display device, and acquires input data from the user.

The term “department theme information” refers to data representing a high-level operational objective or policy assigned to an organizational unit, such as a production efficiency improvement theme or a quality enhancement theme, which is used as an input parameter for target prediction and evaluation.

The term “grade information” refers to data representing a difficulty level, importance level, or evaluation level associated with a task or objective, which is used as a categorical or numerical feature in prediction and evaluation processing.

The term “past production information” refers to historical numerical or categorical data related to production activities, including at least production quantity, operation time, and downtime, which are stored in the storage device and used as training or reference data.

The term “past quality information” refers to historical numerical or categorical data related to product or process quality, including at least defect quantity, defect rate, or quality classification, which are stored in the storage device and used as training or reference data.

The term “feature data” refers to structured data derived from raw production and quality data and from input parameters such as department theme information and grade information, the structured data being formatted into numerical or encoded values suitable for input to a machine learning model.

The term “statistical learning software” refers to a software component, such as a machine learning library or framework, that provides functions for training, validating, and applying predictive models, including at least regression models, based on feature data and outcome data.

The term “regression model” refers to a predictive model, implemented by statistical learning software, that outputs a numerical prediction for a target variable, such as a production target value, based on input feature data.

The term “baseline production target value” refers to a predicted numerical target value for production performance, such as a daily production quantity, generated by the regression model before any correction or refinement by a generative AI model.

The term “generative AI model” refers to a machine learning model, such as a large language model, that receives a prompt sentence as input and generates natural language text or other structured output as a response.

The term “prompt sentence” refers to a text string or sequence of tokens that encodes contextual information, constraints, and instructions provided to a generative AI model to elicit a contextually relevant response.

The term “final production target value” refers to a production target value that results from correcting or approving a baseline production target value based on a response from a generative AI model and optionally applying additional business rules.

The term “explanation information” refers to natural language text or other structured data that describes the rationale, background, or context for a final production target value or an achievement judgment, the text or data being obtained or derived from a generative AI model response.

The term “achievement production information” refers to data representing actual production performance during an evaluation period, including at least production quantity and optionally quality-related performance, which are used for achievement evaluation.

The term “comment information” refers to text data or annotation data input by a user, describing observations, issues, or contextual factors related to production performance, and used as part of the evaluation context.

The term “achievement rate” refers to a computed metric representing a degree of achievement with respect to a target, typically expressed as a ratio or percentage of actual performance relative to a production target value.

The term “primary achievement judgment result” refers to an initial categorical or graded evaluation output that classifies the achievement degree, such as “achieved,” “almost achieved,” or “not achieved,” generated by rule-based logic or a machine learning model using numerical performance metrics.

The term “textual evaluation information” refers to natural language text that explains or assesses an achievement degree, performance status, or contributing factors, which is generated based on a response from a generative AI model.

The term “improvement proposal information” refers to natural language text or structured recommendations that describe suggested actions or strategies for improving future production or quality performance, generated based on a response from a generative AI model.

The term “emotion analysis engine” refers to a software component that processes voice data or image data to estimate an emotional state of a user, using techniques such as speech analysis, facial expression recognition, or other affective computing methods.

The term “emotion state” refers to a classification or representation of a user's affective condition, such as stress, satisfaction, frustration, or confidence, inferred by the emotion analysis engine from voice data or image data.

The term “display data” refers to structured data, including numerical values, textual content, and visualization parameters, that is generated by the server for presentation on a display device, the data optionally including graph data or chart data.

The term “visualization software” refers to a software component that generates graphical or chart-based representations of numerical and categorical data, such as bar charts, line graphs, or other visual elements, for inclusion in display data.

The term “comparison visualization data” refers to visualization data that represents a comparison between the final production target value and the achievement production information, in a graphical or chart-based format that enables visual recognition of deviations and trends.

The term “approval status” refers to state data indicating whether a final production target value has been confirmed, accepted, or otherwise approved by a user, stored in the storage device and used for subsequent processing or record-keeping.

The term “evaluation period” refers to a defined time interval, such as a day, week, or month, over which production performance is measured and for which achievement production information and achievement judgments are generated.

The term “achievement judgment result” refers to an overall evaluation output that may include at least the primary achievement judgment result and optionally a secondary achievement judgment result, reflecting the final classification of achievement degree.

The term “secondary achievement judgment result” refers to an additional or refined evaluation output produced after a secondary evaluation step, such as an evaluation based on an additional prompt sentence and response from a generative AI model.

In one embodiment, a server operates as a central information processing apparatus that coordinates acquisition of production-related data, execution of machine learning models and generative AI models, and generation of visualization data. The server comprises a processor, a storage device, a communication interface, and one or more software modules implemented, for example, using a general-purpose programming language such as Python and software libraries such as a data-processing library, a machine-learning library, and a visualization library. The server executes program code stored in the storage device to implement the functions described below.

The server uses the communication interface to communicate with one or more terminals. Each terminal operates as a client information processing apparatus, such as a tablet terminal, a desktop workstation, or an industrial human-machine interface device. The terminal includes an input unit such as a keyboard, mouse, or touch panel, a microphone or camera for acquisition of voice data or image data of a user, and a display device for presentation of numerical and graphical information. The user operates the terminal to provide input data, confirm or approve targets, and review evaluation results.

The server stores in the storage device a plurality of data structures. The server stores historical production information and historical quality information, for example, in relational tables or indexed files. Each record of the historical production information may include fields such as: line identifier, production date, produced quantity, number of defective units, machine operation time, downtime duration, and associated department theme and grade. Each record of the historical quality information may include fields such as: inspection result, defect category, severity level, and associated batch identifier. The server also stores configuration data defining department themes and grades, model parameters for regression models and neural network models, prompt templates for a generative AI model, and parameters for rule-based logic used in primary achievement judgments.

The server uses data-processing software, such as a data-frame based processing library, to read the historical production information and historical quality information from the storage device into in-memory tabular structures. The server converts the data into feature data suitable for machine learning algorithms. The server, for example, generates numerical feature vectors by combining statistical aggregates of production quantities (such as average daily production and standard deviation), quality-related ratios (such as defect rate computed as defective units divided by produced units), time-based features (such as day-of-week and season indicators), and encoded categorical features representing department theme information and grade information. The server uses encoding schemes, such as one-hot encoding or ordinal encoding, to represent the department theme information and grade information as numerical feature values.

The server constructs a regression model as a prediction module for baseline production target values. In one embodiment, the server uses a linear regression model or a regularized linear model implemented by a machine-learning library. The server trains the regression model by providing to the model a matrix of feature vectors as input and a vector of historical outcome values, such as actual achieved daily production quantities, as target outputs. The server minimizes a loss function, such as mean squared error, by iteratively adjusting weight parameters of the regression model using an optimization algorithm, such as gradient descent or a variant thereof. The server may normalize or standardize feature values to improve numerical stability of the training process. The server stores the trained model parameters in the storage device for subsequent prediction operations.

In another embodiment, the server constructs a non-linear regression model or ensemble model, such as a decision-tree based regression model, to capture non-linear correlations between department theme information, grade information, and achievable production levels.

The server may select a model type based on validation metrics computed on held-out validation data, thereby improving prediction accuracy and robustness against noise in the historical production information.

The server additionally integrates a generative AI model as a natural-language reasoning and explanation module. In one embodiment, the generative AI model is implemented as a large neural network trained on a large corpus of text data, such as a transformer-based language model with multiple self-attention layers. The generative AI model receives a prompt sentence as a sequence of tokens and generates a sequence of output tokens representing natural language text. The generative AI model may be hosted on a remote AI service and accessed by the server through the communication interface, or may be deployed on a local computation node communicatively coupled to the server.

The server generates a prompt sentence by combining department theme information, grade information, statistical summaries of historical production information and historical quality information, and the baseline production target value predicted by the regression model. The server uses stored prompt templates and inserts relevant numerical and textual values into template placeholders to create a concrete prompt sentence. Examples of such prompt sentences include:

“The department theme is ‘improvement of production efficiency’, and the grade is 3. Historical data show an average daily production of 2000 units with a defect rate of 1.5%. A regression model suggests a new baseline target of 2200 units per day. As a generative AI model, please evaluate whether this target is realistic and propose a final daily production target together with a brief explanation within 150 words.”

“For a production line with the theme ‘quality enhancement’ and grade 2, historical data indicate an average defect rate of 2.0% and an average daily production of 1500 units. Please propose an optimal combination of a daily production target and a defect-rate target that is realistic yet challenging, and provide your reasoning.”

The server transmits the prompt sentence to the generative AI model, receives text output from the generative AI model, and analyzes the text output to extract numerical proposals and explanatory statements. The server may apply pattern-matching rules or numerical parsing logic to detect numeric expressions, such as “2200 units per day” or “defect rate of 1.3%,” and to extract them as candidate target values. The server then compares the candidate target values with the baseline production target value predicted by the regression model and applies predefined constraints, such as maximum allowable percentage deviation or capacity limits derived from machine specifications stored in the storage device. By combining the regression model output and the generative AI model output in this way, the server provides a technically improved target value that accounts both for statistically inferred feasibility and for higher-level reasoning captured in the generative AI model.

The server, by integrating the regression model and the generative AI model, improves the computational behavior of the system. The regression model provides fast, deterministic predictions based on structured feature vectors, enabling low-latency calculation of baseline production targets. The generative AI model provides flexible natural language reasoning that can incorporate contextual constraints and business rules not explicitly encoded in the regression model, reducing the need for manual rule-writing. By offloading complex natural language reasoning to the generative AI model and encapsulating the invocation of the model behind a structured prompt sentence generation mechanism, the server reduces development complexity and facilitates consistent, reproducible interactions. Furthermore, the server's use of a compact set of numerical summaries in the prompt sentence reduces communication bandwidth between the server and the generative AI service compared to transmitting raw historical data, thereby reducing communication load and improving response latency.

The server also implements an achievement evaluation module that operates after the evaluation period. The terminal allows the user to input achievement production information, such as actual daily production quantities and observed defect counts, and comment information, such as explanations for deviations or descriptions of process improvements. The terminal transmits these data to the server, which stores them as records associated with the corresponding final production target value.

The server computes evaluation metrics by applying arithmetic operations to the stored data. For example, the server calculates an achievement rate as the ratio of actual production to the final production target value and computes changes in defect rate relative to historical averages. The server applies rule-based logic, such as threshold-based classification rules, to categorize achievement rates into levels like “achieved,” “almost achieved,” and “not achieved.” Alternatively or additionally, the server applies a classification model implemented by a machine-learning library, trained using labeled historical achievement outcomes. In this case, the server constructs feature vectors including achievement rate, change in defect rate, frequency of downtime events, and other indicators, and uses a supervised learning algorithm, such as logistic regression, to learn model parameters from training data. The server then outputs a primary achievement judgment result for each evaluation period.

The server supplements this primary judgment by generating a second prompt sentence for the generative AI model. The server includes in the second prompt sentence at least the final production target value, actual achieved values, defect-rate changes, and the primary achievement judgment result. An example of such a prompt sentence is:

“The production line had a daily target of 2200 units. The actual average was 2150 units per day. The defect rate improved from 1.5% to 1.2%. The primary achievement judgment is ‘Almost achieved’. As a generative AI model, please evaluate this performance in a balanced way, considering both quantity and quality, and provide three concrete suggestions for further improvement.”

The server transmits this second prompt sentence to the generative AI model and receives a narrative evaluation and improvement proposal information. The server stores this textual evaluation information and improvement proposal information in the storage device and links it to the corresponding achievement records. By delegating narrative synthesis to the generative AI model while maintaining quantitative judgment logic in the server, the system improves separation of concerns and avoids duplicating natural language logic in the server code. This architecture results in shorter server-side code paths, faster execution of numerical evaluation, and flexible adaptation of narrative style by simply changing the prompt sentence or underlying generative AI model.

The server further integrates an emotion analysis engine as a multimodal analysis module. The terminal captures voice data via the microphone and image data via the camera when the user interacts with the system, for example, during target confirmation or evaluation review. The terminal transmits the captured data to the server. The server uses the emotion analysis engine, implemented for example as a neural network model with convolutional layers for image analysis or recurrent/transformer layers for speech signal analysis, to estimate emotion states such as stress, frustration, or satisfaction. The emotion analysis engine may be trained using supervised learning with labeled emotion datasets, minimizing a cross-entropy loss function by adjusting weight parameters through backpropagation. The server uses the output emotion state as an additional feature when interpreting achievement results and generating or adjusting textual evaluations. For example, if the emotion analysis suggests a high stress level, the server may adjust the textual evaluation information to emphasize supportive feedback and specific guidance rather than purely critical comments. By incorporating emotion-based adjustments into the evaluation pipeline, the server improves human-computer interaction quality and promotes better acceptance of AI-based evaluations.

The server uses visualization software to generate display data for presentation on the terminal. The server constructs graph data and chart data representing comparisons between final production target values and achievement production information, as well as time-series trends for production quantities and defect rates. The server may, for example, generate bar charts showing target versus actual values per day, line graphs illustrating temporal trends, and gauge-style indicators summarizing achievement rates. The server encodes visualization parameters, such as axis ranges, color schemes, and annotation texts, into structured objects and transmits these objects to the terminal. The terminal then renders the graphs and charts using its local rendering engine. By centralizing visualization data generation in the server, the system ensures consistency across terminals and reduces computation requirements at the terminal side, contributing to scalable deployment in factory environments.

The server thereby achieves technical improvements in several respects. First, by using feature-based regression models trained on historical production information and historical quality information, the server provides more accurate and stable target predictions than fixed rule-based approaches, reducing forecasting error and enabling more efficient production planning. Second, by generating compact, information-rich prompt sentences and offloading complex reasoning and narrative generation to a generative AI model, the server reduces its own computational complexity while still providing sophisticated contextual analysis and explanation, resulting in improved overall system responsiveness. Third, by incorporating emotion analysis outputs as an additional signal in achievement evaluation, the server enables adaptive feedback generation that cannot be practically achieved by manual rule-coding, thus enhancing the technical functioning of the evaluation pipeline. Fourth, by standardizing visualization generation at the server level, the system optimizes bandwidth and ensures consistent, reproducible display behavior across heterogeneous terminals.

In additional embodiments, the server may vary the machine learning algorithms and network architectures used. For example, the server may use a feedforward neural network with multiple hidden layers and non-linear activation functions as the regression model, trained with stochastic gradient descent and regularization techniques such as dropout. The server may also incorporate data augmentation techniques for training the emotion analysis engine, such as time-stretching or noise injection for audio data and geometric transformations for image data, to improve robustness. The server may store multiple versions of models and select among them at runtime based on evaluation metrics stored in the storage device. The server may further compress model parameters using quantization or pruning techniques to reduce memory usage and accelerate inference, especially when deploying portions of the models to edge devices.

The terminal and the user interact with the server in a way that exploits these improvements in computer technology. The user does not directly implement target-calculation rules or manually create narrative evaluations; instead, the user simply provides department theme information, grade information, and periodic production data. The server's coordination of regression modeling, generative AI reasoning via structured prompt sentences, emotion-based adjustment, and visualization data generation provides an integrated, technically enhanced computing functionality that goes beyond mere automation of human judgment and leads to improved prediction accuracy, faster processing, reduced communication load, and more effective use of stored production and quality data.

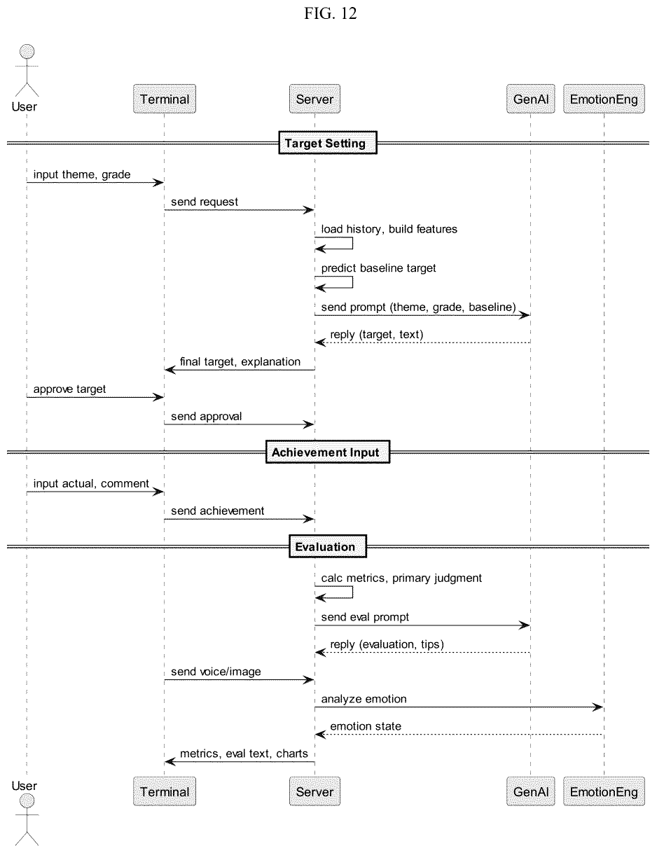

The following describes the processing flow using FIG. 12.

### Step 1:

Server initializes internal modules and loads configuration data.

Server uses the storage device to load configuration parameters, including database connection settings, model file paths, prompt sentence templates for a generative AI model, and thresholds for achievement judgment.

Input: configuration files and stored model parameters.

Processing: Server parses the configuration files, establishes connections to a data store, and loads regression model parameters and emotion analysis model parameters into memory.

Output: initialized in-memory structures for data processing, model inference, and prompt sentence generation.

### Step 2:

Terminal acquires initial input from the user regarding department theme information and grade information.

User selects a department theme (for example, “improvement of production efficiency”) and a grade (for example, 3) on the terminal screen and confirms the input.

Input: user-selected department theme information and grade information.

Processing: Terminal validates the input format (for example, checks that the grade is within an allowed range) and packages the input into a request message.

Output: request message containing department theme information, grade information, and identifiers such as line identifier and evaluation period.

### Step 3:

Terminal transmits the request message to the server.

Terminal uses a communication protocol to send the department theme information, grade information, and associated identifiers to the server.

Input: validated request message.

Processing: Terminal encodes the message, attaches metadata such as timestamp and user identifier, and sends it via the communication interface.

Output: network packet received by the server containing structured input data.

### Step 4:

Server receives the initial request and stores basic input data.

Server decodes the incoming message and extracts department theme information, grade information, line identifier, and evaluation period.

Input: network packet from the terminal.

Processing: Server performs input validation (for example, checks that the department theme exists in a master table and that the grade is valid), and then writes the input data into a request log or a dedicated table in the storage device.

Output: stored record associating the request with a unique request identifier.

### Step 5:

Server acquires historical production information and historical quality information.

Server queries the storage device for records that match the line identifier and an appropriate historical time window.

Input: request identifier, line identifier, and time-range criteria.

Processing: Server executes queries, reads historical data into in-memory tabular structures, and filters out records that do not meet minimum completeness requirements.

Output: datasets of historical production information and historical quality information associated with the target line.

### Step 6:

Server preprocesses the historical data and generates feature data.

Server applies data-processing software to clean and transform the acquired datasets.

Input: raw historical production information and historical quality information.

Processing: Server removes records with missing or inconsistent values, computes derived metrics such as defect rate and average daily production, encodes categorical fields (including department theme information and grade information) into numerical vectors, and aggregates statistics by period or line.

Output: feature matrix representing multiple observations and a corresponding target vector representing historical outcome values.

### Step 7:

Server applies a regression model to predict a baseline production target value.

Server uses a trained regression model loaded in memory to compute a numerical prediction.

Input: feature vector corresponding to the current department theme information, grade information, and line characteristics.

Processing: Server normalizes input features if necessary, feeds them into the regression model, and performs a matrix-vector multiplication and bias addition to obtain a predicted value.

Output: baseline production target value for the specified evaluation period (for example, 2200 units per day).

### Step 8:

Server prepares a prompt sentence for the generative AI model based on prediction results and historical context.

Server combines structured numeric and textual information into a natural-language prompt sentence.

Input: department theme information, grade information, historical averages and defect rates, and the baseline production target value.

Processing: Server selects an appropriate prompt template, replaces placeholders with actual values (for example, “average daily production 2000 units,” “defect rate 1.5%,” and “baseline target 2200 units”), and concatenates the elements into a coherent prompt sentence.

Output: fully constructed prompt sentence ready to be sent to the generative AI model.

### Step 9:

Server transmits the prompt sentence to the generative AI model and receives a response.

Server uses the communication interface to send the prompt sentence to a generative AI service.

Input: prompt sentence.

Processing: Server wraps the prompt sentence in a request format required by the generative AI model, sends it, waits for a response, and then decodes the response into plain text.

Output: text response from the generative AI model containing candidate target values and explanatory paragraphs.

### Step 10:

Server analyzes the generative AI response and determines a final production target value.

Server extracts numeric information and explanation content from the generative AI response.

Input: baseline production target value and generative AI response text.

Processing: Server applies pattern detection to identify numeric expressions in the response, compares extracted values with the baseline production target value, checks for deviations beyond allowable thresholds, and applies correction rules (for example, averaging or capping).

Output: final production target value and explanation information associated with the target.

### Step 11:

Server stores the final production target value and related metadata.

Server creates or updates records in the storage device to reflect the final target decision.

Input: final production target value, explanation information, department theme information, grade information, and request identifier.

Processing: Server writes these values to target-setting tables, links them to the originating request and line identifier, and records timestamps for audit purposes.

Output: persistent records for later evaluation and display.

### Step 12:

Server transmits the final production target value and explanation information to the terminal.

Server prepares a response message containing numeric and textual data.

Input: final production target value and explanation information.

Processing: Server formats the data into structured fields (for example, target quantity, justification text, and evaluation period) and sends the message via the communication interface.

Output: response message delivered to the terminal.

### Step 13:

Terminal displays the final production target value and explanation to the user.

Terminal renders the received data in user interface components.

Input: response message from the server.

Processing: Terminal parses the message, updates on-screen labels to show the final production target value (for example, “2200 units/day”) and the explanation text, and enables confirmation controls such as buttons.

Output: visual presentation on the display device and interactive controls for user confirmation.

### Step 14:

User confirms or rejects the final production target value.

User reviews the displayed target and explanation and then operates the terminal to issue a confirmation action.

Input: displayed final production target value and explanation.

Processing: User decides whether to accept the target and interacts with a confirmation control (for example, pressing an “Approve Target” button).

Output: user confirmation status captured by the terminal.

### Step 15:

Terminal transmits the confirmation status to the server.

Terminal converts the user's action into an electronic message.

Input: user confirmation status (for example, approved/not approved) and associated request identifier.

Processing: Terminal packages the status into a structured message and sends it back to the server over the communication interface.

Output: confirmation status message received by the server.

### Step 16:

Server records the approval status for the target.

Server updates the storage device to mark the final production target value as approved or not approved.

Input: confirmation status message.

Processing: Server locates the corresponding target record using the request identifier and writes an approval flag and timestamp to the record.

Output: updated target-setting record reflecting user approval.

### Step 17:

Terminal acquires achievement production information and comment information at the end of the evaluation period.

User inputs actual production results and comments via the terminal interface.

Input: actual daily or total production values, defect counts, downtime durations, and optional textual comments from the user.

Processing: Terminal validates numerical ranges, ensures that required fields are filled, and groups all input into a summary for the evaluation period.

Output: achievement data package containing achievement production information and comment information.

### Step 18:

Terminal transmits the achievement data package to the server.

Terminal uses the communication interface to send collected data to the server.

Input: achievement data package and identifiers such as line identifier and evaluation period.

Processing: Terminal serializes the data into a structured message and sends it to the server.

Output: achievement data message received by the server.

### Step 19:

Server computes achievement metrics and generates a primary achievement judgment result.

Server performs arithmetic and logical operations on the achievement data.

Input: achievement production information, final production target value, and historical reference values if needed.

Processing: Server calculates the achievement rate as the ratio of actual production to the final production target value, computes changes in defect rate compared to historical averages, and applies predefined rules or a classification model to map these metrics to categories such as “achieved,” “almost achieved,” or “not achieved.”

Output: numeric metrics (achievement rate, defect-rate delta) and a primary achievement judgment result.

### Step 20:

Server generates a second prompt sentence for achievement evaluation by the generative AI model.

Server prepares a natural-language description of the evaluation situation.

Input: final production target value, achievement metrics, primary achievement judgment result, and comment information.

Processing: Server selects a prompt template for evaluation, inserts numeric values (such as target, actual, and defect rates) and textual descriptors (such as the primary achievement judgment), and forms a coherent sentence or paragraph.

Output: second prompt sentence describing performance and requesting narrative evaluation and improvement suggestions.

### Step 21:

Server transmits the second prompt sentence to the generative AI model and receives an evaluation response.

Server interacts again with the generative AI service.

Input: second prompt sentence.

Processing: Server sends the prompt sentence, waits for the generative AI model to generate a response, and receives a narrative evaluation and improvement proposal text.

Output: textual evaluation information and improvement proposal information generated by the generative AI model.

### Step 22:

Server acquires user voice data or image data from the terminal and performs emotion analysis.

Terminal sends recorded voice or captured images associated with the evaluation session.

Input: voice data or image data of the user, linked to the evaluation period.

Processing: Server uses an emotion analysis engine to transform raw signals into feature representations (for example, acoustic features or facial landmarks), applies a trained neural network to classify emotion states, and outputs labels such as “high stress” or “satisfied.”

Output: estimated emotion state associated with the user during evaluation.

### Step 23:

Server adjusts evaluation outputs based on emotion state.

Server modifies evaluation details using the emotion estimate.

Input: primary achievement judgment result, textual evaluation information, improvement proposal information, and emotion state.

Processing: Server applies adjustment rules (for example, selecting more supportive wording if stress is high, or highlighting strengths if the user appears discouraged), and may re-rank or filter improvement proposals to prioritize actionable and non-overwhelming suggestions.

Output: adjusted textual evaluation information and possibly updated achievement judgment annotations.

### Step 24:

Server generates visualization data for display on the terminal.

Server creates visual representations from numeric evaluation metrics and target-actual comparisons.

Input: final production target value, achievement production information, achievement metrics, and evaluation results.

Processing: Server uses visualization software to create encoded graph and chart specifications, such as bar charts comparing target and actual values, line plots of time-series performance, and summary indicators for achievement rate, and packages these specifications into a display data structure.

Output: display data including graphical definitions, labels, and legends.

### Step 25:

Server transmits evaluation results and visualization data to the terminal.

Server bundles all relevant evaluation outputs into a response message.

Input: adjusted textual evaluation information, improvement proposal information, achievement metrics, and visualization data.

Processing: Server assembles these elements into a structured message and sends it to the terminal via the communication interface.

Output: evaluation result message delivered to the terminal.

### Step 26:

Terminal displays the evaluation results and visualizations to the user.

Terminal renders both text and graphs on the display device.

Input: evaluation result message from the server.

Processing: Terminal parses the message, maps visualization data to graphical components, draws charts and graphs, and displays textual evaluation information and improvement proposals alongside numerical metrics.

Output: comprehensive evaluation screen presented to the user, enabling review of performance, understanding of generative AI-based feedback, and planning of future actions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional goal management and performance evaluation systems typically rely on static rule sets or manual review of free-form text, stored and processed by generic database and reporting components. In such systems, servers merely collect achievement descriptions and execute fixed scoring logic, without dynamically adapting to the semantics of user input or to the user's emotional state. As a result, the server's information processing functions are limited in their ability to transform unstructured input into accurate, consistent, and context-aware evaluation data. This leads to several technical problems in computer-implemented performance evaluation.

First, when a server processes free-form achievement descriptions using only simple keyword matching or rule-based logic, the resulting scores are highly sensitive to the specific wording and may fail to capture the true content of the achievement. The information processing pipeline on the server side cannot robustly interpret nuances such as relative improvement, cross-project impact, or implicit constraints, thereby degrading the quality of downstream data aggregation and visualization. Consequently, the server's data structures and scoring algorithms store and propagate low-fidelity evaluation signals, which limit the usefulness of subsequent analysis and visualization modules.

Second, existing systems typically lack an integrated mechanism on the server to generate machine-interpretable instructions (prompts) for an external or internal generative AI model and to combine AI-based evaluation information with rule-based scores. In many cases, generative AI models are invoked ad hoc, with unstructured prompts and without a stable interface tied to well-defined data models. This results in inconsistent latency, unpredictable output formats, and difficulties in integrating AI outputs into numerical scoring pipelines. From the standpoint of computer technology, the server is not architected to coordinate deterministic data processing (such as database operations and statistical aggregation) with probabilistic AI inference in a unified, reliable evaluation flow.

Third, conventional architectures do not exploit user emotional state as a structured signal within the evaluation pipeline. While some systems capture audio or video data for separate analysis, they do not integrate emotion recognition results into the same scoring data path on the server. The absence of a standardized emotion analysis function and associated data structures means that the server cannot adjust evaluation decisions based on user stress, frustration, or confidence, even when such signals are available. This disconnect causes the system to underutilize multimodal data, leading to technically suboptimal decision criteria and reduced robustness of the evaluation output.

Fourth, visualization components in conventional systems often operate as thin clients that simply render raw scores or tabular data pushed from the server. The server is not configured to generate structured visual representation data, such as graph or chart data objects derived from time-series or category-based aggregation of achievement degrees. As a result, the burden of data transformation is shifted to the client, which complicates client-side scripts, increases data transfer volume, and makes it difficult to guarantee consistent rendering across heterogeneous terminals. From a computer-technical perspective, this leads to inefficient utilization of server-side processing capabilities and fragmented responsibility for data formatting.

Accordingly, there is a need for an improved computer-implemented system in which a processor on a server side is specifically configured to: (i) acquire and store achievement content information in a structured manner; (ii) compute a primary numerical achievement degree using rule-based evaluation; (iii) generate structured prompt sentences and interact with a generative AI model in a controlled way; (iv) integrate AI-derived evaluation with emotion analysis results obtained from multimodal input; and (v) generate visual representation data for efficient server-driven visualization. By addressing these issues, the invention aims to improve the functioning of the server-side computer system itself, including its data processing pipeline, integration of heterogeneous computational components, and the efficiency and accuracy of automated evaluation and display operations.

The specific processing by the specific processing unit 290 of the data processing device 12 in Example 2 is realized by the following means.

The present invention provides a server comprising a processor configured to act as a centralized information processing resource, to acquire achievement content information as structured data from a terminal device via an input/display interface, to store the structured achievement content information in association with identification information and time information in a storage information management device, to execute aggregation and analysis processing that extracts word information and numerical information from the stored achievement content information and calculates a numerical primary achievement degree by comparison with preset evaluation standard information, to generate prompt sentences based on the achievement content information and the primary achievement degree, to transmit the prompt sentences to a generative AI model and acquire evaluation information from the generative AI model, to perform a primary determination of an achievement degree based on the evaluation information, to analyze user voice information and facial expression information acquired from an audio acquisition device and an image acquisition device by using an emotion analysis function so as to recognize a user emotional state, to supplement the primary determination of the achievement degree based on the user emotional state and thereby determine a final achievement degree by integrating the primary achievement degree and the evaluation information, and to generate visual representation information including graph or chart data by converting the final achievement degree and explanation information obtained from the generative AI model and to output evaluation result information to an information display device. This enables an improved computer-implemented evaluation pipeline in which the server-side processor coordinates deterministic rule-based scoring, structured prompt generation, generative AI inference, multimodal emotion analysis, and server-driven visualization, thereby enhancing the accuracy, robustness, and efficiency of performance evaluation operations executed by the computer system.

The term “processor” refers to a hardware or virtual processing unit configured to execute machine-readable instructions, including a central processing unit, a graphics processing unit, or any other computation resource capable of performing the described operations.

The term “terminal device” refers to an information processing apparatus operated by a user, including but not limited to a personal computer, a mobile computing device, or any other client device equipped with a browsing function.

The term “browsing information processing function” refers to software executed on the terminal device that interprets and displays content written in a description language and script language, such as a web browser or equivalent rendering engine.

The term “information input/display device” refers to a combination of hardware and software that provides an interface for receiving user input and presenting information, including a display panel, an input unit, and associated control logic.

The term “input/output control function” refers to a software-implemented mechanism that manages the transfer of data between user interface elements and underlying application logic, including event handling, form processing, and communication with a server.

The term “description language” refers to a markup or presentation language used to define the structure and layout of an input screen or display screen, including but not limited to a text-based markup language.

The term “script language” refers to a programming language interpreted or executed by the browsing information processing function to implement dynamic behavior and communication on an input or display screen.

The term “achievement content information” refers to electronically represented data describing outcomes, results, or performance of a user with respect to one or more goals or tasks, typically expressed in natural language text and associated attributes.

The term “structured data format” refers to a data representation in which fields and values are organized according to a predefined schema, including but not limited to key-value pairs, tabular data, or hierarchical data objects.

The term “identification information” refers to data used to uniquely or distinctively associate achievement content information with a subject, such as a user, a group, or a record, including identifiers, codes, or equivalent reference data.

The term “time information” refers to data indicating a temporal aspect of a record, including a timestamp, date, period, or time interval related to the acquisition, storage, or evaluation of achievement content information.

The term “storage information management device” refers to a hardware and software combination configured to store, retrieve, and manage data structures, including a database system, a file storage system, or any persistent storage subsystem.

The term “aggregation processing function” refers to a software-implemented capability of the processor to perform operations that combine, group, or summarize multiple data records based on specified criteria, including statistical, analytical, or computational operations.

The term “evaluation standard information” refers to predefined reference data representing criteria, thresholds, or rules used to evaluate or score achievement content information.

The term “primary achievement degree” refers to a numerical or otherwise quantified value representing an initial evaluation of the achievement content information, computed based on comparison with evaluation standard information.

The term “generative AI model” refers to a machine-implemented model that generates outputs such as text, scores, or structured data in response to input prompts, using learned statistical relationships derived from training data and including neural network-based models.

The term “prompt sentence” refers to a machine-readable instruction or query expressed in a natural or formal language and supplied as input to the generative AI model to elicit a corresponding output.

The term “evaluation information” refers to data output by the generative AI model in response to a prompt sentence, including at least one of a numerical score, a categorical rating, and explanatory text related to achievement content information.

The term “primary determination of an achievement degree” refers to a first-stage decision or assessment of a user's achievement level, made by the processor based on evaluation information obtained from the generative AI model.

The term “audio acquisition device” refers to hardware configured to capture sound, including microphones and associated signal processing components.

The term “image acquisition device” refers to hardware configured to capture still or moving image data, including cameras and associated signal processing components.

The term “emotion analysis function” refers to a software-implemented capability that processes audio information, image information, or other user-related data to infer an emotional state, using pattern recognition, statistical analysis, or machine learning techniques.

The term “emotional state” refers to an inferred condition of a user's affect or mood, such as stress, confidence, satisfaction, or frustration, derived from analysis of multimodal input data.

The term “final achievement degree” refers to a numerical or otherwise quantified value representing a consolidated evaluation of a user's achievement, obtained by integrating at least a primary achievement degree and evaluation information and optionally emotion analysis results.

The term “explanation information” refers to descriptive data that explains or justifies an evaluation or score, including narrative text or structured comments generated by the generative AI model or by rule-based logic.

The term “display control function” refers to a software-implemented mechanism that formats and outputs data for presentation on a display device, including the generation of graphical elements, layout control, and rendering instructions.

The term “visual representation information” refers to data structures specifying graphical or visual forms of information, such as coordinates, labels, and style attributes for charts, graphs, or other visual elements.

The term “evaluation result information” refers to information generated by the processor for presentation to a user, including the final achievement degree, associated explanation information, and any visual representation information.

The term “organizational unit” refers to a logical or physical subdivision within an entity, such as a department, team, or group, used as a basis for defining management themes and goals.

The term “management theme” refers to a conceptual or operational focus area for an organizational unit, such as productivity, quality, or customer satisfaction, used to guide the setting of goal information.

The term “goal information” refers to data representing desired targets, objectives, or expected outcomes for users or groups, including qualitative descriptions and quantitative metrics.

The term “grade” refers to a classification level, such as a role level, position level, or responsibility level, used to differentiate goal information and evaluation criteria across users.

The term “graph format” refers to a visual representation type in which data is depicted using graphical primitives such as bars, lines, points, or curves corresponding to numerical values or categories.

The term “chart format” refers to a visual representation type that organizes data into structured visual layouts such as bar charts, pie charts, line charts, or equivalent diagrammatic forms.

The term “statistical processing function” refers to a software-implemented capability that performs statistical operations on data, including aggregation, averaging, dispersion analysis, and trend computation.

The term “transition information” refers to data indicating changes of a value, such as the final achievement degree, over time, categories, or other dimensions, used to analyze trends or progression.

The term “graph or chart data” refers to structured data prepared for rendering a graph or chart, including data series, labels, axes definitions, and formatting parameters.

In one embodiment, a server operates as a central information processing device and cooperates with terminals operated by users. The server includes one or more processors, a main memory, a nonvolatile storage device, and a communication interface connected to a communication network. The server executes server-side application software implemented, for example, using a Python runtime environment and a web application framework. The server further cooperates with a data management system implemented as a relational database system and with an external or internal generative AI model service exposed via an application programming interface.

A terminal operates as a client device that provides an input and display interface to a user. The terminal includes a display unit, an input unit such as a keyboard or pointing device, a communication interface, and a local processor executing a web browser or equivalent browsing software. The terminal loads an input screen and a result screen described in a markup language such as HTML and a scripting language such as JavaScript. The terminal renders input forms, transmits structured data such as JSON-formatted achievement content to the server, and renders evaluation results and visual representations returned by the server.

A user operates the terminal to input achievement content related to goals. The user views the input screen on the terminal display, types free-text achievement descriptions, selects classification items such as organizational unit and period, and submits the data. The user later views evaluation scores, textual explanations, and visualization graphics on the terminal display, and adjusts future goals based on this feedback.

The server uses the relational database system as a storage information management device. In one embodiment, the server uses a relational table structure having columns for user identifiers, organizational unit identifiers, grade levels, raw achievement text, time information, base scores, AI-based scores, final scores, and emotion analysis indicators. The server uses a data analysis library, such as a data frame processing library, to perform aggregation processing and evaluation calculations on data retrieved from the relational database.

The server uses a generative AI model as a text generation and evaluation engine. In one embodiment, the generative AI model is implemented as a transformer-based neural network having multiple encoder-decoder layers, self-attention mechanisms, and positional encoding. The generative AI model is trained on a collection of domain-independent text and optionally fine-tuned on domain-specific evaluation text. The model parameters include weight matrices for multi-head attention, feed-forward layers, layer normalization parameters, and token embedding matrices. The model is trained using stochastic gradient-based optimization, such as Adam or a related optimizer, with a cross-entropy loss function or a combined loss function including both language modeling loss and auxiliary regression loss for score prediction. The generative AI model receives a prompt sentence as a sequence of tokens and outputs a continuation that includes both natural language explanation and optionally structured markers indicating score values or categorical ratings.

The server uses an emotion analysis function to infer a user emotional state from audio or image data. In one embodiment, the emotion analysis function is realized by a convolutional or recurrent neural network trained on labeled emotional speech data or facial expression data. The server receives raw audio signals from a microphone or video frames from a camera as part of the terminal or associated equipment. The server extracts feature vectors such as Mel-frequency cepstral coefficients from audio or facial landmark coordinates from images, and the emotion analysis network maps these features to probabilities over emotional categories such as “stressed”, “confident”, or “neutral”. The server stores these emotion indicators alongside achievement records and uses them as an additional signal for evaluation.

The server defines data structures specialized for goal management and evaluation. For achievement content stored in the relational database, the server associates the following fields: a primary key identifier, a user identifier, an organizational unit identifier, a grade identifier, a goal identifier, a period identifier, raw achievement text, tokenized achievement text, extracted numerical values, extracted keywords, a primary achievement degree, an AI-based score, a final achievement degree, an emotional state indicator, and timestamps. By structuring data in this manner, the server is able to perform efficient index-based lookups, aggregation by user or period, and incremental updates to scores without scanning unrelated records, thereby reducing database query latency and improving throughput.

The server uses a rule-based evaluation module as an aggregation processing function. This module uses a set of evaluation standard information stored as configuration records. Each record maps a keyword pattern, phrase pattern, or numerical range to a scoring contribution. For example, patterns such as “ahead of schedule”, “under budget”, or “increased by [X]%” are associated with weighting coefficients. The server uses tokenization and pattern matching to detect these patterns in the tokenized achievement text. The server then computes a primary achievement degree by summing or otherwise combining the contributions from matched patterns, optionally normalizing the result to a predetermined scale such as 0 to 100.

The server uses vectorized operations in the data analysis library to perform these computations efficiently across many records, which reduces processing time compared to row-by-row evaluation.

The server uses the generative AI model to complement the rule-based primary achievement degree. The server constructs a prompt sentence for each achievement record. In one example, the server generates the following prompt sentence as plain text:

“Based on the following achievement description, evaluate the user's achievement level on a 0-100 scale and explain the reasons briefly: ‘I completed Project A ahead of schedule and increased sales by 20%.’”

In another example, the server generates a prompt sentence including organizational and temporal context:

“Read the following achievement description for a sales department employee in Q3: ‘I completed Project A ahead of schedule and increased sales by 20%.’ Please provide a score from 0 to 100 and a brief explanation of your evaluation.”

The server may also generate a prompt sentence for secondary determination:

“Based on the primary achievement score of 88 and the following description: ‘I completed Project A ahead of schedule and increased sales by 20%.’, please review and adjust the score if necessary, and provide a final score from 0 to 100 with one paragraph of explanation.”

The server transmits such prompt sentences to the generative AI model using a communication protocol such as HTTPS. The server includes control parameters such as maximum output length, temperature, and top-k or top-p sampling values to regulate output diversity and determinism. The server receives the generated text, parses markers indicating a suggested score, and extracts the explanatory part. This AI-based score is stored as evaluation information and is combined with the primary achievement degree.

The server integrates the primary achievement degree, the AI-based score, and the emotion analysis output to determine a final achievement degree. In one embodiment, the server uses a weighted combination where the weights depend on the reliability of the AI score and the detected emotional state. For example, if the emotion analysis indicates high stress, the server may slightly adjust the final score upward or attach caution flags to suggest additional review. The server defines explicit rules or a separate model for mapping emotion categories and discrepancies between the primary and AI-based scores into adjustment values. This integration process improves the robustness of evaluation by using multimodal data and reduces systematic bias that might arise from textual phrasing alone.

The server generates visual representation information for evaluation results. The server aggregates final achievement degrees by period, organizational unit, and grade, using group-by and statistical functions in the data analysis library. The server computes summary statistics such as averages, medians, and standard deviations, and constructs data objects representing graph or chart configurations, including axes labels, series values, and color assignments. The server then transmits these data objects to the terminal, which renders bar charts, line graphs, or radar charts using client-side scripting. Because the server already generates compact, structured visual representation information, the amount of data transmitted over the network is reduced, and the terminal-side processing is simplified.

The server improves computer technology in several ways. First, the server transforms unstructured textual achievement content into structured, multi-level evaluation data using a combination of deterministic rules, neural network-based language modeling, and emotion recognition. This reduces noise in the stored data and enhances the signal quality for subsequent computational analysis. Second, the server defines and uses specialized data structures and vectorized aggregation processing, which increase throughput and reduce processing time compared to naive implementations that would process each achievement record sequentially. Third, the server offloads complex semantic interpretation and multimodal fusion to dedicated modules and provides standardized interfaces between them, which improves modularity and maintainability of the software architecture. Fourth, by generating prompt sentences and parsing AI outputs according to a strict protocol, the server converts inherently probabilistic AI interactions into reliable, machine-consumable evaluation information, thereby enabling predictable and repeatable system behavior.

The server uses a neural network-based generative AI model in a manner that is not a mere automation of human judgment. The server encodes domain-specific structures into the prompt sentence, such as explicit mention of numerical results, context fields, and primary scores. The generative AI model processes long-range dependencies between different parts of the achievement text, which would be difficult and time-consuming for human evaluators to process at large scale. The model learns latent representations of typical achievement patterns, degrees of difficulty, and impact indicators. During inference, the model uses attention mechanisms to focus on relevant phrases and numerical entities, leading to more nuanced scoring and explanation than simple keyword rules. By combining such deep representations with rule-based scores and emotion analysis, the server achieves lower variance in evaluation outcomes and improved alignment with objective metrics.

The server also improves communication efficiency. Because the server consolidates raw text, AI-based evaluation, and emotion analysis into compact numerical scores and visual representation data before transmitting to the terminal, network bandwidth usage is reduced relative to systems that would send large amounts of raw data and let the client perform all processing. This design is particularly advantageous in environments with many terminals or limited network capacity.

In another embodiment, the server operates an internal generative AI model deployed on dedicated hardware accelerators such as graphics processing units or tensor processing units. The server allocates batches of prompt sentences from multiple users to the model in a single inference batch, thereby improving computation efficiency and throughput. The server can also use model quantization, pruning, or distillation, which reduce the memory footprint and accelerate inference while maintaining acceptable evaluation quality. These techniques further contribute to reduction in computation time and energy consumption, which are technical improvements to the operation of the computer system.

In a further embodiment, the server supports alternative generative AI models with different architectures, such as encoder-only models for classification-oriented evaluation or decoder-only models for generative explanations. The server uses a model selection mechanism that dynamically selects an appropriate model based on input length, required latency, or required output type. The server may also maintain a fallback rule-based mode in case of AI service unavailability, ensuring reliability of operation.

In another embodiment, the terminal is implemented as a mobile device. The terminal performs preliminary processing such as basic input validation, local caching of input data, and user interface rendering with adaptive layouts. However, the terminal delegates all evaluation logic, AI interaction, and visualization data preparation to the server. This separation allows low-power terminals to participate without needing heavy local computation.

In yet another embodiment, the emotion analysis function is executed partially on the terminal. For instance, the terminal extracts audio or image features and transmits only low-dimensional feature vectors to the server. The server then performs emotion classification using a neural network model. This architecture reduces the amount of raw media data sent over the network and addresses privacy and bandwidth concerns, while still enabling the server to integrate emotion analysis into the evaluation pipeline.

The described embodiments may be combined or modified in various ways. The server may support multiple organizational units, each with its own management themes and evaluation standards. The server may maintain different rule sets or generative AI fine-tuning parameters per unit. The server may also expose an application programming interface for integration with external systems such as human resource management systems, while maintaining the described internal data structures and processing flow to ensure consistent and technically improved evaluation performance.

Through these embodiments, the server, the terminal, and the user cooperate in a manner that allows the computer system to perform complex, high-volume evaluation operations with improved accuracy, speed, and robustness, beyond what is feasible with conventional rule-only systems or manual evaluation. The particular combination of structured data management, rule-based scoring, generative AI inference with prompt sentences, and multimodal emotion analysis yields technical effects that directly improve the functioning of the computer system itself.

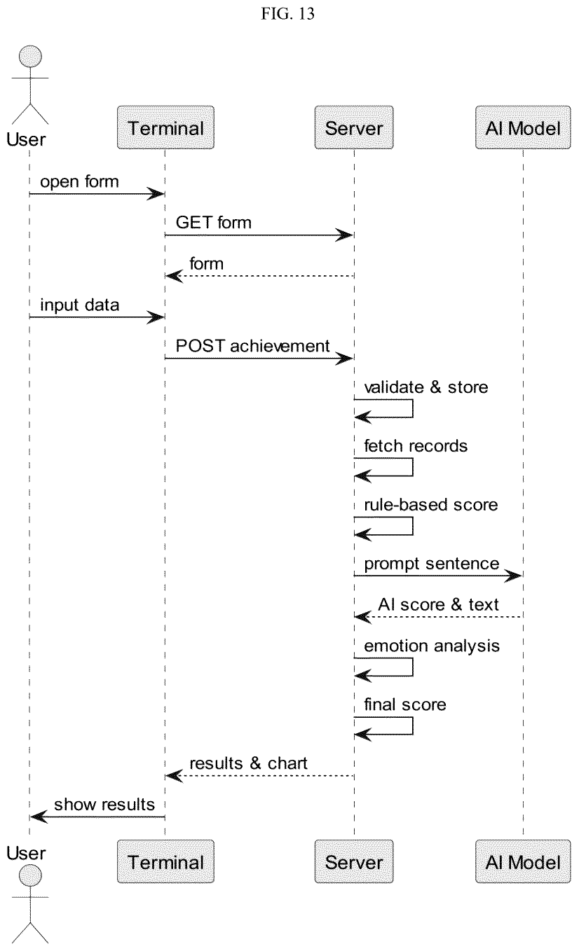

The following describes the processing flow using FIG. 13.

### Step 1:

The terminal displays an achievement input screen.

The terminal receives, as input, markup and script files from the server and renders an input form that includes text fields, selection boxes, and buttons. Based on this input, the terminal executes a browsing application to parse the markup, lay out visual components, bind event handlers to form elements, and output an interactive screen on the display unit. The terminal thereby converts network-transferred code into a concrete graphical interface that can accept user operations.

### Step 2:

The user inputs achievement content and related attributes.

The user receives, as input, the visual form displayed on the terminal and performs operations such as typing text, selecting items, and pressing a submit button. Based on these operations, the user provides achievement content (for example, descriptions of completed tasks and quantitative results) and contextual information (such as organizational unit, period, and grade). The user's actions output updated field values in the terminal's form model, which become available as structured data for further processing.

### Step 3:

The terminal constructs structured achievement data and transmits it to the server.

The terminal takes, as input, the current values of all form fields, including the achievement text and associated identifiers. The terminal executes a script to read these values, assemble them into a structured object, and encode the object into a structured data representation. The terminal then computes a request payload and outputs a network message containing the structured achievement data addressed to a specific endpoint on the server. In this step, the terminal transforms user interface state into machine-readable data and initiates communication with the server.

### Step 4:

The server receives and validates the structured achievement data.

The server accepts, as input, the network message from the terminal, including the structured achievement data. The server executes request-handling logic to decode the message, parse the structured data into internal variables, and verify that required fields are present and correctly formatted. The server performs data-type checks, length checks, and simple consistency checks. The server outputs either an error response if the data is invalid or a normalized achievement record ready to be inserted into persistent storage if the data is valid.

### Step 5:

The server stores the normalized achievement record in a data management system.

The server receives, as input, the normalized achievement record including user identifiers, organizational unit identifiers, grade information, raw achievement text, and time information. The server executes database-access logic to map the record fields to columns in a relational table and generates storage commands. The server then sends these commands to the data management system, which physically writes the record to nonvolatile storage. The server outputs a confirmation message to the terminal and a stored record with a unique identifier that can be referenced in later evaluation processing.

### Step 6:

The server retrieves stored achievement records for evaluation.

The server takes, as input, a set of selection criteria, such as a user identifier, a time period, or a flag indicating that records have not yet been evaluated. Based on these criteria, the server executes a query against the data management system to fetch matching records. The server receives the resulting records, loads them into an in-memory data structure such as a tabular collection, and outputs a batch of achievement records ready for rule-based evaluation and AI-based processing.

### Step 7:

The server preprocesses achievement text and extracts features.

The server receives, as input, the batch of achievement records containing raw achievement text. The server converts all text to a normalized form, applies tokenization to split the text into tokens, and removes or marks punctuation and stop words. The server then performs pattern detection to identify keywords and numerical expressions, such as percentage changes or quantity improvements. The server outputs, for each record, a feature representation consisting of token lists, identified keywords, and numerical values that can be used as inputs to the scoring algorithms.

### Step 8:

The server calculates a primary achievement degree based on rule-based evaluation.

The server takes, as input, the feature representations of each achievement record and the evaluation standard information that maps patterns to scoring contributions. For each record, the server compares extracted keywords and numerical values against the evaluation standard information and computes a contribution score for each match. The server applies aggregation functions, such as summation and normalization, to produce a numeric primary achievement degree on a predefined scale. The server outputs, for each achievement record, a primary achievement degree that captures a deterministic evaluation based on explicit rules.

### Step 9:

The server generates a prompt sentence for the generative AI model.

The server receives, as input, each achievement record's raw text, contextual data (such as organizational unit and period), and the primary achievement degree. The server composes a natural-language prompt sentence that embeds this information in a structured manner. For example, the server generates a prompt sentence such as: “Based on the following achievement description for an employee in the sales department in Q3, with a primary score of 88, evaluate the user's achievement level on a 0-100 scale and explain the reasons briefly: ‘I completed Project A ahead of schedule and increased sales by 20%.’” The server outputs, for each record, a prepared prompt sentence that can be directly consumed by the generative AI model.

### Step 10:

The server transmits the prompt sentence to the generative AI model and obtains evaluation information.

The server takes, as input, the prepared prompt sentence and configuration parameters for the generative AI model such as maximum output length and sampling parameters. The server passes the prompt sentence to the generative AI model through a defined interface and instructs the model to generate an output. The generative AI model processes the prompt sentence and returns an output sequence that includes a suggested score and an explanatory text. The server receives this output, parses the suggested score and explanation, and outputs evaluation information consisting of an AI-based score and an explanation string for each achievement record.

### Step 11:

The server acquires and analyzes user emotion data.

The server receives, as input, acoustic signals from an audio acquisition device and image frames from an image acquisition device associated with the user. The server applies feature extraction algorithms to derive acoustic features or facial landmark coordinates and passes these features to the emotion analysis function. The emotion analysis function computes probabilities of different emotional states and outputs an emotion category and confidence value. The server associates this emotion indicator with the corresponding achievement record and outputs emotion analysis data that can influence the final evaluation.

### Step 12:

The server integrates rule-based, AI-based, and emotion-based information to determine a final achievement degree.

The server takes, as input, the primary achievement degree from the rule-based evaluation, the AI-based score and explanation from the generative AI model, and the emotion analysis data. The server applies a combination algorithm that may weight the primary achievement degree and AI-based score and optionally adjust the result based on the emotion indicator. For example, the server may compute a weighted average and apply bounded adjustments when the emotion state suggests underreporting or overreporting. The server outputs, for each record, a final achievement degree and an associated explanation that reflects the combined evidence from rules, AI inference, and emotion analysis.

### Step 13:

The server generates visual representation information for evaluation results.

The server receives, as input, the final achievement degrees and associated metadata, such as user identifiers, periods, and organizational units. The server groups records according to requested dimensions, calculates summary metrics like averages and trends, and constructs data objects specifying graph or chart formats. The server defines axis scales, labels, series values, and color mappings. The server outputs compact visual representation information that describes how final achievement degrees and trends should be rendered on the terminal.

### Step 14:

The terminal receives and renders evaluation results and visual representations.

The terminal accepts, as input, the evaluation result information and visual representation data sent by the server. The terminal's browsing application parses this data, updates existing document elements or creates new graphical components, and draws charts, graphs, and textual explanations on the display. The terminal converts the server-provided data structures into pixel-level output, and outputs an updated screen in which the user can see final scores, explanations, and visual summaries.

### Step 15:

The user reviews evaluation results and adjusts future goals.

The user receives, as input, the rendered evaluation results, including the final achievement degrees, AI-generated explanations, and visual charts. Based on this information, the user interprets their performance, identifies strengths and weaknesses, and may decide to adjust planned goals or strategies. The user outputs new or updated achievement or goal inputs in subsequent interactions, which the terminal again captures and transmits to the server, thereby closing the loop for continuous evaluation and improvement.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional goal-management and performance-evaluation systems generally treat target setting, achievement evaluation, process efficiency analysis, and user-interface presentation as separate functions implemented by hand-crafted rules. In such systems, targets are often defined manually or by simple fixed formulas, primary and secondary evaluations are computed by static threshold logic, and feedback is limited to rigid, non-adaptive messages rendered on a display. As a result, these systems exhibit several technical limitations.

First, existing architectures are not capable of dynamically generating machine-processable evaluation logic from heterogeneous operational data and natural-language inputs. When operators, workers, or other users input free-form achievement descriptions, conventional systems either ignore these descriptions or perform only shallow keyword matching. The systems do not generate prompt sentences suitable for interaction with a generative AI model, nor do they systematically log and reuse those prompts and outputs to improve the underlying evaluation algorithms. This leads to sub-optimal utilization of available computational resources and prevents the system from adapting its evaluation behavior to changing data patterns.

Second, conventional systems do not integrate multimodal sensing, such as emotion recognition from audio and image data, into the core computation of achievement scores in a technically robust manner. Even when an emotion analysis engine is present as a separate module, its outputs are rarely coupled into the numerical evaluation pipeline in a way that can consistently adjust or supplement an existing score. As a result, the processing pipeline cannot use emotion information as a formal signal for refining evaluation results, and the system fails to optimize internal decision thresholds, weighting factors, or secondary evaluation logic based on emotional context.

Third, known systems lack an integrated mechanism to convert AI-generated improvement suggestions into machine-readable control parameters or control commands for downstream apparatuses such as production equipment or business devices. In typical deployments, improvement proposals are presented only as natural-language text to human operators, who must manually interpret and translate the proposals into system settings. This manual translation introduces latency, inconsistency, and errors, and prevents closed-loop optimization in production or business processes.

Fourth, existing visualization subsystems are usually decoupled from both AI evaluation results and emotion states. Graphs and charts are rendered with static styles, irrespective of the user's emotional state or the reliability and provenance of the underlying AI results. There is no data flow whereby emotion labels, achievement scores, and efficiency indices jointly determine display parameters such as color tone or emphasis level. Consequently, the user interface cannot effectively communicate system-internal evaluations and confidence measures, nor can it adapt its presentation to enhance user comprehension or response time.

Fifth, conventional systems do not provide a unified logging and learning framework which captures, in a structured way, the prompt sentences used with generative AI models, the corresponding outputs, and the final achievement scores and control actions. Without such a framework, it is difficult to audit system behavior, detect systematic over- or under-estimation patterns, or automatically generate updated prompt templates and evaluation algorithms. This lack of feedback severely limits the system's ability to self-improve and to maintain consistent performance over time as data distributions shift.

Accordingly, there is a need for a technical architecture that (i) programmatically generates and manages prompt sentences for interaction with a generative AI model, (ii) integrates multimodal emotion analysis into primary and secondary achievement evaluations, (iii) converts AI-generated improvement suggestions into structured control commands for apparatuses, (iv) adapts visualization parameters based on emotion-aware evaluation results, and (v) continuously logs and exploits AI interactions to refine evaluation and control logic. Such an architecture would improve the operation of the underlying computer system itself by enabling more efficient use of processing resources, more accurate and context-aware computation of achievement scores, and more reliable, low-latency feedback and control in complex operational environments.

The specific processing by the specific processing unit 290 of the data processing device 12 in Application Example 2 is realized by the following means.

The present invention provides a server comprising a processor and memory storing instructions, the instructions, when executed by the processor, causing the processor to generate prompt sentences to be input to a generative AI model for setting target values for grades based on an organizational theme and past performance data, to input the prompt sentences and numerical data to the generative AI model to generate the target values, to record numerical and textual achievement data input by an individual, to generate prompt sentences for performing a primary evaluation of an achievement degree based on comparison between the achievement data and the target values and analysis of the textual achievement data, to input the prompt sentences and the achievement data to the generative AI model to obtain primary evaluation results and to integrate the primary evaluation results into achievement scores through numerical calculation, to estimate an emotional state by processing audio data and facial image data of the individual using an emotion analysis engine, to execute adjustment processing that supplements the evaluation of the achievement degree based on the achievement scores and the emotional state and to calculate final achievement scores, to calculate a work efficiency index based on time-series data collected from a process, to generate prompt sentences summarizing evaluation information including the final achievement scores and the work efficiency index and to input the prompt sentences and related data to the generative AI model to generate improvement suggestion information, to convert a part of the improvement suggestion information corresponding to apparatus control into control parameters or control commands and to transmit the control parameters or control commands to an apparatus to optimize operation of the apparatus, to generate display data that visually represents the final achievement scores, the work efficiency index, the emotional state, and the improvement suggestion information in graphs, charts, and text feedback on an information display device with a display format that is varied in accordance with the emotional state, and to associate and record the prompt sentences, outputs of the generative AI model, and the final achievement scores, and to generate learning data for updating evaluation algorithms or prompt sentences based on the recorded information. This enables improvement of operation of the computer system by providing a tightly integrated, machine-driven pipeline in which generative AI interaction, multimodal emotion analysis, numerical evaluation, adaptive visualization, and apparatus control are coordinated to produce more accurate, context-aware achievement scores and to realize closed-loop optimization of processes with reduced computational waste, lower latency, and enhanced adaptability over time.

The term “processor” refers to a hardware computing element, such as a central processing unit or other execution unit, that executes instructions to perform arithmetic operations, logical operations, control operations, and data transfer operations.

The term “generative AI model” refers to a software-implemented artificial intelligence model that, in response to an input prompt sentence, generates new output data including natural-language text, numerical values, or structured information, by using learned parameters obtained from training on sample data.

The term “prompt sentence” refers to text data provided as an input instruction to a generative AI model, the text data specifying a task to be executed by the generative AI model and a context or constraint under which the task is to be executed.

The term “organizational theme” refers to information that indicates a policy, goal, or direction for a group or division within an organization, and that is used as a basis for determining target values for tasks or grades.

The term “past performance data” refers to previously recorded data representing results of tasks, operations, or activities, including numerical results such as quantities or times and categorical results such as status values, which are used for analysis when generating target values.

The term “grade” refers to a classification level or rank assigned to an individual, group, or task, which level or rank is used to differentiate target values or evaluation criteria among entities.

The term “target value” refers to a numerical or categorical value that defines an intended level of achievement or performance for a task, process, or period, and that serves as a reference when computing an achievement degree.

The term “achievement data” refers to information input by an individual that represents results actually obtained for a task or period, including numerical information such as quantities and times, and textual information such as descriptive statements.

The term “primary evaluation result” refers to an intermediate evaluation value of an achievement degree obtained by comparing achievement data with target values or by analyzing the achievement data using a generative AI model before any adjustment based on emotion information.

The term “achievement score” refers to a numerical value, such as a percentage or a normalized score, that quantitatively represents an achievement degree for at least one target value based on achievement data and evaluation processing.

The term “emotion analysis engine” refers to a software-implemented processing component that analyzes input data representing at least one of audio data and image data to estimate an emotional state of an individual.

The term “audio data” refers to time-series data representing sound, such as a voice signal of an individual, which is obtained by an audio acquisition device and processed for emotion estimation.

The term “facial image data” refers to image data that includes at least a portion of a face of an individual, which image data is obtained by an image acquisition device and processed for emotion estimation.

The term “emotional state” refers to information indicating a psychological state of an individual, such as joy, neutrality, frustration, fatigue, or other emotion categories, optionally with intensity values, which information is estimated by the emotion analysis engine.

The term “final achievement score” refers to a numerical value representing an achievement degree after adjustment of an achievement score based on an estimated emotional state or a secondary evaluation process.

The term “time-series data” refers to data in which measurements, events, or counts are associated with time indices, and that represent changes in process state or performance over time.

The term “work efficiency index” refers to a numerical value indicating efficiency of an operation or process, computed based on time-series data by comparing actual performance with a standard or target performance.

The term “evaluation information” refers to information including at least one of a final achievement score, a work efficiency index, an emotional state, and intermediate evaluation values, which information is used as a basis for further processing or feedback.

The term “improvement suggestion information” refers to information generated by a generative AI model that describes proposed changes to tasks, processes, or control parameters in order to improve achievement degree or work efficiency.

The term “apparatus control” refers to an operation in which information generated by a computing system is converted into a control parameter or control command and is applied to a machine, equipment, or device to change its operational behavior.

The term “control parameter” refers to a numerical or symbolic setting value, such as speed, threshold, interval, or mode, which is applied to a machine, equipment, or device to modify its operation.

The term “control command” refers to a structured instruction, such as a message or signal, that directs a machine, equipment, or device to perform a particular operation or change state.

The term “production apparatus” refers to a machine, equipment, or device used in a production process to manufacture, assemble, or process goods, and whose operation can be controlled by a control parameter or a control command.

The term “business apparatus” refers to a device or system that executes business-related operations such as data processing, workflow execution, or information management, and whose operation can be modified by control parameters or control commands.

The term “information display device” refers to a device including at least a display unit configured to visually present information, such as a terminal, workstation, or panel, which receives display data from a server.

The term “display data” refers to data defining visual presentation content and style, including numerical values, text strings, graphical elements, and layout or color information, which are used by an information display device to render an image.

The term “graph or chart” refers to a visual representation of data, such as a bar graph, line graph, pie chart, gauge, or similar figure, that is generated from numerical or categorical values for presentation on a display.

The term “text feedback” refers to natural-language text that describes evaluation results, explanations, or suggestions provided to a user as part of a feedback process.

The term “display format” refers to a set of parameters defining how information is rendered on a display, including color tone, brightness, emphasis level, font, size, or graphical highlighting.

The term “learning data” refers to data prepared for use in improving or retraining an algorithm, including recorded prompt sentences, model outputs, final achievement scores, and associated metadata, which are used to update evaluation logic or prompt templates.

The term “evaluation algorithm” refers to a computational procedure, implemented in software, that receives input data such as achievement data and target values and outputs at least one of an achievement score, a work efficiency index, or a decision result.

In one embodiment, a server cooperates with one or more terminals to implement the claimed system. The server includes at least one processor, a memory, a non-volatile storage device, and a network interface. The terminal includes at least one processor, a memory, a display unit, an audio acquisition device such as a microphone, and an image acquisition device such as a camera. The server and the terminal communicate over a communication network using a transport protocol such as HTTP or HTTPS.

The server stores, in the non-volatile storage device, a program implemented for example in a programming language such as Python, which is executed by the processor. The server also stores trained parameters of a generative AI model, trained parameters of an emotion analysis engine, and configuration data including organizational themes, grade information, and target generation policies. In one example, the generative AI model is implemented as a large-scale transformer-based neural network, including a plurality of encoder-decoder layers, multi-head self-attention layers, feed-forward layers, and layer normalization modules. The emotion analysis engine includes a convolutional neural network for image-based facial expression recognition and a recurrent or transformer-based network for audio-based emotion recognition.

The server uses a relational database system, such as a generic SQL database, to store structured records including organizational theme data, past performance data, target values, primary and final achievement scores, emotion logs, improvement suggestion information, and audit logs of prompt sentences and generative AI model outputs. The server defines explicit data structures, such as a target table with fields (user_id, grade_id, task_id, period_id, target value), an achievement table with fields (user_id, task_id, period_id, numeric_result, text_description, primary_score, final_score), and an emotion log table with fields (user_id, session_id, emotion_label, emotion_intensity, timestamp).

The terminal provides a user interface implemented, for example, as a web application executed in a generic web browser or as a native application. The terminal displays input forms for organizational themes, targets, and achievement data, and renders graphs, charts, and text feedback based on display data sent from the server. The terminal acquires audio data and facial image data from the user when the user inputs achievement data, and transmits these data to the server.

The server executes a target generation process using the generative AI model. The server first loads organizational themes and past performance data from the database into memory. The server performs preprocessing such as normalization of numerical values, computation of statistical indicators such as means and standard deviations, and encoding of categorical attributes as vector representations. The server then constructs a prompt sentence in natural language, embedding structured values into a text template. For example, the server generates a prompt sentence such as:

“Based on the past three months' production data and the department theme ‘increase monthly production volume by 10%’, generate realistic grade-specific targets for operators A, B, and C. Output numeric targets and short justifications.”

The server then tokenizes the prompt sentence, converts tokens into embeddings, and inputs the resulting sequence to the generative AI model. The generative AI model processes the embeddings through stacked attention layers and feed-forward layers to produce an output sequence representing target values and explanatory text. The server decodes the output sequence, performs pattern matching or regular expression parsing to extract numerical target values, and stores the target values in the target table. By generating the target values through the generative AI model driven by prompt sentences that encode both past numerical data and high-level themes, the server avoids using rigid, hand-coded formulas and instead uses a flexible, data-driven representation that can adapt to new patterns in the performance data.

The server receives achievement data from the terminal. The terminal causes the user to select a task and period and to input numerical results, such as produced quantity or achieved sales, and textual descriptions, such as self-reports regarding completion status or encountered issues. The terminal transmits the input values to the server together with metadata such as user identifier, task identifier, and timestamps.

The server combines the input achievement numerical values with corresponding target values from the target table. The server performs arithmetic operations, such as computing ratios of actual values to target values and converting the ratios to achievement percentages.

In addition, the server processes the textual descriptions using a text feature extractor, for example, a recurrent neural network or transformer encoder, to compute semantic embeddings. The server may construct a prompt sentence that includes both the text description and computed numerical context. For example, the server generates a prompt sentence such as:

“Given the following self-report: ‘I completed project A two days ahead of schedule and improved defect handling’, assign an achievement score between 0 and 100 and explain the reasoning in two sentences.”

The server tokenizes this prompt sentence, concatenates the token sequence with encoded features representing the numeric achievement ratio, and inputs the combined representation to the generative AI model. The generative AI model generates an output sequence containing a proposed score and explanation. The server extracts the proposed score, for example by matching a pattern such as “Score: X”, and combines this score with the previously computed numeric ratio, for example using a weighted average. The resulting value becomes a primary achievement score. Because the generative AI model operates on both numeric and textual features encoded within the prompt sentence, the server integrates complex narrative information and quantitative measures into a unified score, which is not feasible with simple threshold-based rules.

The server uses the emotion analysis engine to estimate the user's emotional state. For facial image data, the server applies an image preprocessor that performs face detection, cropping, and normalization to a fixed size. The server then forwards the processed face images to a convolutional neural network having multiple convolutional layers, pooling layers, and fully connected layers trained to output probability distributions over emotion classes such as joy, neutral, anger, sadness, and fatigue. For audio data, the server extracts acoustic features such as mel-frequency cepstral coefficients, pitch contours, and energy statistics, and inputs the features to an audio emotion model, for example a recurrent network or transformer trained for emotion classification. The server fuses the outputs of the image-based and audio-based networks, for example by weighted averaging or a small fusion network, and determines a final emotion label and intensity score.

The server supplements the primary achievement score based on the estimated emotional state. The server applies a rule set or an additional neural network that receives as inputs the primary achievement score, the emotion label, and the emotion intensity, and outputs an adjustment value. For example, the server may decrease the score when the emotion label indicates frustration and the primary score is near a decision boundary, in order to reduce false positives. The server may increase the score when the emotion label indicates joy and the textual description indicates early completion. The server may also construct a prompt sentence for a secondary evaluation using the generative AI model, such as:

“Primary achievement score: 78. Detected user emotion: ‘frustration’. Adjust the final achievement score between 0 and 100, and explain the adjustment in one short paragraph.”

The server sends this prompt sentence to the generative AI model together with encoded numeric features. The generative AI model outputs an adjusted score and explanation. The server validates that the adjusted score is within allowable bounds and that the adjustment satisfies predefined constraints, and then stores the adjusted value as a final achievement score. By using both algorithmic rules and generative AI interaction driven by prompt sentences, the server introduces non-linear, context-dependent adjustments that go beyond simple human-defined thresholds, thereby improving robustness against noisy or ambiguous data.

The server calculates a work efficiency index using time-series data collected from a process. The server obtains time-stamped events, such as produced units, cycle times, machine stops, or error codes, from sensors or controllers connected to the production apparatus or business apparatus. The server stores these events in a time-series data structure and computes features such as moving averages, standard deviations, inter-arrival time distributions, and frequency of short stops. The server inputs these features to a regression or anomaly-detection model implemented, for example, in a neural network or gradient-boosted decision tree. The model outputs an efficiency index, for example between 0 and 1, indicating how closely the current operation matches an ideal pattern learned from historical high-performance data.

The server generates improvement suggestion information by constructing a prompt sentence that summarizes the final achievement score, the work efficiency index, and key feature values. For example, the server may generate:

“You are an expert production manager. Analyze the following data and propose three concrete improvement suggestions. Final achievement score: 82. Efficiency index: 0.90. Main issues: frequent short machine stops and unbalanced work distribution between stations 2 and 3.”

The server embeds structured feature descriptions into the prompt sentence and sends the sentence to the generative AI model. The generative AI model produces natural-language proposals, such as changes to task allocation or maintenance operations. The server parses the proposals and maps specific ones to apparatus control actions when they refer to parameters that can be translated into control parameters or control commands.

The server performs apparatus control by converting a subset of the improvement suggestion information into machine-readable commands. For example, when the generative AI model suggests reducing conveyor speed or adjusting inspection intervals, the server maps these textual suggestions to numeric values based on control policies stored in configuration data.

The server then constructs control commands, for example in an industrial communication format, and transmits the commands to the production apparatus or business apparatus via the network interface. The apparatus applies the new parameters to control motors, sensors, or software modules. This closed-loop architecture provides a direct technical effect in the physical world, such as reduced machine stoppages, more stable throughput, or decreased error rates.

The server generates display data for the terminal. The server aggregates the final achievement scores, work efficiency indices, emotion labels, and improvement suggestion information into a data structure that describes visual elements, such as chart types, color codes, text strings, and layout positions. The server determines color tones and emphasis levels based on the emotion labels, such that positive emotions correspond to brighter colors and negative emotions correspond to subdued tones. The server transmits the display data to the terminal as structured messages.

The terminal receives the display data and renders graphs and charts using a visualization library, for example a JavaScript-based graphing engine. The terminal displays bar graphs comparing target values and actual values, line graphs showing score trends over time, and annotation texts explaining evaluations and improvement suggestions. The terminal also renders visual emphasis, such as highlighting low scores with warning colors. By encoding visualization parameters in the display data and controlling them based on internally computed technical metrics, the server improves the informativeness and responsiveness of the user interface beyond static dashboards.

The server records, in an audit log, each prompt sentence used for interaction with the generative AI model, the outputs produced by the model, the corresponding numerical scores and control actions, and contextual metadata such as timestamps and model identifiers. The server periodically analyzes this log using offline batch processes. For example, the server compares generative AI-proposed scores with verified outcomes and calculates error statistics and bias indicators. The server uses this information to update evaluation algorithms, weighting factors, and prompt templates. For instance, the server may adjust the structure of prompt sentences to emphasize numerical features when it detects that textual narratives lead to systematic overestimation. This feedback loop improves the computational accuracy and stability of the system over time.

The server trains and updates the generative AI model and emotion analysis engine using training datasets. For the generative AI model, the server prepares training pairs consisting of prompt sentences and desired outputs. The server defines a loss function, such as cross-entropy loss over token predictions combined with a mean-squared error term for numeric values embedded in the outputs. The server applies gradient-descent-based optimization, such as the Adam optimizer, to update model parameters. For the emotion analysis engine, the server uses labeled audio and image datasets and trains convolutional and recurrent architectures using supervised learning with cross-entropy loss. The server may perform data augmentation, such as random cropping, rotation, and noise addition, to improve robustness. By implementing explicit training and updating mechanisms, the server achieves improved prediction accuracy and reduces misclassification of emotions, which in turn reduces erroneous adjustments of achievement scores.

The described architecture improves computer technology in several ways. The server introduces a structured pipeline that converts heterogeneous data (numeric, text, image, audio, time-series) into unified internal representations and uses prompt sentences as a tightly controlled interface to a generative AI model. This design allows dynamic generation of evaluation logic, target values, and improvement suggestions without embedding fixed rules in code, which enhances adaptability and reduces the need for manual reprogramming. The fusion of emotion analysis results with numerical evaluation scores produces a composite metric that is less sensitive to noise and outliers, thereby reducing false positives and false negatives in achievement classification. The conversion of generative AI outputs into concrete control parameters and control commands realizes closed-loop optimization that cannot be performed merely by displaying textual recommendations to humans.

Compared with systems that rely only on static rule sets and direct human interpretation, the server reduces computational waste by sharing feature extraction modules across multiple tasks, such as evaluation and optimization, and by using cached intermediate representations. The server reduces communication overhead by transmitting compressed display data and control commands instead of full raw data streams. The server enables faster decision making by performing evaluations and control translation automatically upon receipt of new data, eliminating delays associated with manual review. Because the server logs all prompt sentences and model outputs and uses them as learning data for refining algorithms, the system can continually adapt to changing data distributions, improving accuracy, stability, and processing throughput.

In another embodiment, the server employs alternative model architectures. For example, the generative AI model may be realized as a sequence-to-sequence recurrent neural network with attention, and the emotion analysis engine may use a three-dimensional convolutional network to process video sequences instead of still images. In still another embodiment, a simpler rule-based module may perform the initial primary evaluation using deterministic thresholds, and the generative AI model may be used only for secondary evaluation and explanation generation. In all these variations, the server maintains the technical core: generation and use of prompt sentences to interact with a generative AI model, integration of multimodal emotion analysis into score computation, translation of AI-generated suggestions into apparatus control commands, and adaptive visualization of evaluation results.

In a further embodiment, the terminal may be implemented as an industrial operator panel with limited computing power, and most heavy computations, including generative AI inference and emotion analysis, may be performed on the server or on a separate computing node. In another variation, a portion of the emotion analysis may be executed on the terminal using an optimized lightweight model to reduce network latency for emotion estimation. These alternative configurations still rely on the server to orchestrate data storage, prompt sentence management, generative AI interaction, score computation, and apparatus control. Through these embodiments and variations, the system as implemented by the server and the terminal realizes a technical improvement in how computer systems generate and apply evaluation and control logic, thereby enhancing precision, speed, and robustness of performance evaluation and apparatus operation in real-world environments.

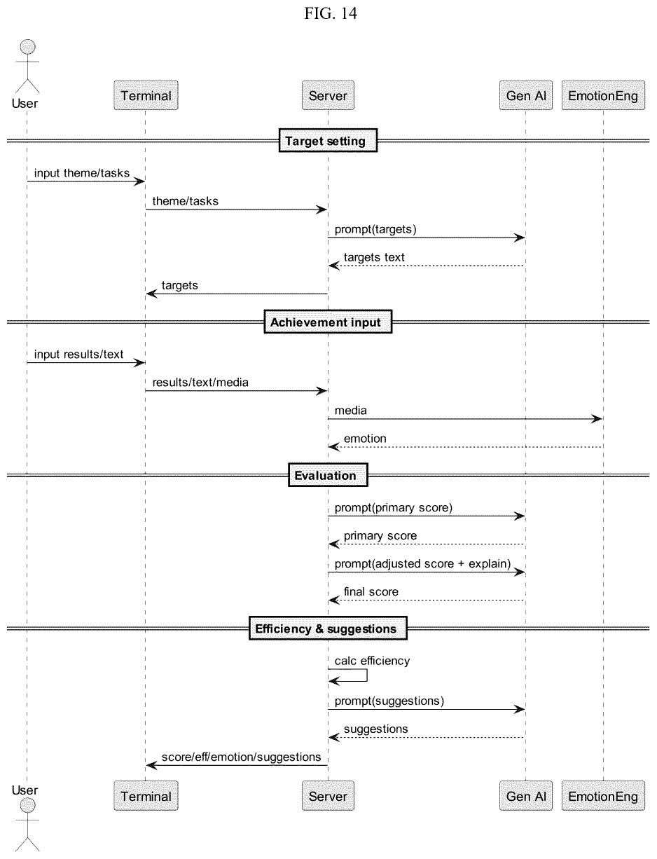

The following describes the processing flow using FIG. 14.

### Step 1:

Server loads configuration and models.

Server receives, as input, configuration data including organizational themes, grade definitions, task identifiers, and past performance records stored in a database. Server also receives, as input, stored parameters of a generative AI model and an emotion analysis engine from non-volatile storage. Server reads the configuration data into memory, initializes internal data structures such as hash maps for fast lookup by user_id and task_id, and loads the generative AI model and emotion models into the processor's memory space. Server outputs initialized in-memory structures ready for subsequent target generation and evaluation processing.

### Step 2:

User defines themes and tasks via the terminal.

User provides, as input, selections of an organizational theme and definitions of tasks and grades on an input screen displayed by the terminal. User enters text fields such as theme description and task name, and selects grade levels from a list. Terminal validates the input format and outputs a structured message including theme text, task identifiers, and grade information. Terminal transmits this message to the server over a network connection as a request payload.

### Step 3:

Server generates target values using the generative AI model.

Server receives, as input, the organizational theme, grade information, and related past performance data for each grade and task. Server preprocesses the numerical performance data by computing aggregated statistics such as average, minimum, maximum, and standard deviation, and converts these statistics into text fragments. Server then constructs a prompt sentence by embedding the theme and the processed statistics into a natural-language template, for example:

“Based on the past three months' production data and the department theme ‘increase monthly production volume by 10%’, generate realistic grade-specific targets for operators A, B, and C. Output numeric targets and short justifications.”

Server tokenizes the prompt sentence, converts tokens to embeddings, and provides the embedding sequence as input to the generative AI model. Generative AI model processing produces, as output, a token sequence representing target values and justifications. Server decodes the sequence, parses numerical values for each grade and task, and outputs a set of target values that the server stores in a target table.

### Step 4:

Terminal displays target values to the user.

Terminal receives, as input, target values and associated justification texts from the server.

Terminal formats these values into table rows and chart data structures. Terminal performs, as data processing, conversion of numeric target values into local display units and calculation of bar lengths or chart coordinates. Terminal outputs a rendered screen that presents target values per grade or user, allowing the user to review and confirm goals.

### Step 5:

User inputs achievement data via the terminal.

User provides, as input, achievement data at the end of a period or after completing tasks.

User enters numeric results such as produced quantity, processed cases, or sales amount, and enters a text description such as “I completed project A two days ahead of schedule and reduced defect rate by 5%.” Terminal optionally records audio and captures facial images while the user is speaking. Terminal performs, as data processing, client-side validation of numeric ranges and required fields, then packages the numeric results, text description, audio data, and image data into a structured message. Terminal outputs this message and transmits it to the server as an achievement submission.

### Step 6:

Server stores raw achievement and media data.

Server receives, as input, the achievement message containing numeric results, text description, and media data for a given user, task, and period. Server writes the numeric and text fields into an achievement table, and stores audio and image data in a file system or object store, recording file paths or identifiers in a media reference table. Server performs indexing of records by user_id, task_id, and period_id to facilitate fast retrieval. Server outputs updated database entries representing raw achievement and media data.

### Step 7:

Server calculates numeric achievement ratios.

Server receives, as input, the stored achievement numeric results and corresponding target values from the target table. Server performs arithmetic operations by computing, for each task and period, a ratio actual_value/target_value, and multiplies this ratio by 100 to obtain an achievement percentage. Server clamps the percentage within predefined bounds, for example between 0 and 150, to avoid extreme values caused by erroneous inputs. Server outputs a numeric achievement percentage and stores this value as a numeric component of the primary achievement score.

### Step 8:

Server evaluates textual achievement with the generative AI model.

Server receives, as input, the user's text description of achievement and the numeric achievement percentage. Server encodes the numeric percentage into a textual phrase or a feature vector. Server then constructs a prompt sentence including both the description and the numeric context, for example:

“Given the following self-report: ‘I completed project A two days ahead of schedule and improved defect handling’, and a numeric achievement ratio of 1.1, assign an achievement score between 0 and 100 and explain the reasoning in two sentences.”

Server tokenizes this prompt sentence, optionally concatenates auxiliary tokens encoding the numeric ratio, and inputs the resulting sequence to the generative AI model. Generative AI model processing produces, as output, a text sequence that includes an explicit score and explanation. Server parses the score using pattern recognition, converts it to a numeric value, and outputs a textual achievement score that the server stores in the achievement table.

### Step 9:

Server combines numeric and textual scores into a primary achievement score.

Server receives, as input, the numeric achievement percentage and the textual achievement score for the same achievement instance. Server executes a data processing operation that computes a weighted average or another aggregation, for example primary_score=0.7×numeric_percentage+0.3×textual_score. Server may also apply normalization or clipping to the aggregated value to maintain consistency across tasks. Server outputs the primary achievement score and records it in the database as an intermediate evaluation result.

### Step 10:

Server estimates user emotion from image and audio data.

Server receives, as input, references to stored audio files and facial image files associated with the achievement submission. Server performs pre-processing on the facial images by applying face detection, cropping, and resizing operations using an image processing library.

Server passes the processed images to a convolutional neural network of the emotion analysis engine, which outputs class probabilities for emotion categories. Server pre-processes audio by extracting time-domain and frequency-domain features and passes these features to an audio emotion classifier. Server fuses image-based and audio-based emotion predictions by computing a weighted sum or by using a fusion network, and outputs a final emotion label and an intensity score. Server writes these values into an emotion log table.

### Step 11:

Server adjusts the achievement score based on emotion.

Server receives, as input, the primary achievement score, the emotion label, and the emotion intensity value. Server executes a rule-based function or a small neural network that maps the combination of these inputs to an adjustment value. For example, if primary_score is near a decision threshold and emotion indicates strong frustration, server reduces the score by a small percentage; if primary_score is high and emotion indicates joy, server confirms or slightly increases the score. Alternatively or additionally, server constructs a prompt sentence to refine the score, such as:

“Primary achievement score: 78. Detected user emotion: ‘frustration’. Adjust the final achievement score between 0 and 100, and explain the adjustment in one short paragraph.” Server sends this prompt sentence and associated numeric features to the generative AI model and receives an adjusted score and explanation. Server validates the adjusted score against constraints, and outputs a final achievement score that it stores in the achievement table as the definitive evaluation value.

### Step 12:

Server computes a work efficiency index from time-series process data.

Server receives, as input, time-stamped process events and sensor readings from production apparatuses or business apparatuses, such as cycle times, produced units, stop events, and error codes. Server stores the events in a time-series structure, then aggregates them into features, for example average cycle time per period, standard deviation, frequency of short stops, and defect rate. Server inputs these features to a trained efficiency model, such as a regression neural network, which computes an index between 0 and 1. Server outputs a work efficiency index and associates it with the relevant user, task, and period.

### Step 13:

Server generates improvement suggestions using the generative AI model.

Server receives, as input, the final achievement score, the work efficiency index, and a set of key features summarizing process performance. Server generates a prompt sentence that embeds these values, for example:

“You are an expert production manager. Analyze the following data and propose three concrete improvement suggestions. Final achievement score: 82. Efficiency index: 0.90. Main issues: frequent short machine stops and unbalanced work distribution between stations 2 and 3.”

Server tokenizes the prompt sentence and sends it to the generative AI model. Generative AI model processing outputs text describing one or more improvement suggestions. Server parses this output, extracts individual suggestions as separate text items, and stores them in an improvement_suggestions table. Server outputs structured improvement suggestion information linked to the corresponding user, task, and period.

### Step 14:

Server converts relevant suggestions into apparatus control commands.

Server receives, as input, the stored improvement suggestions and configuration rules that map suggestion patterns to controllable parameters of apparatuses. Server applies text analysis and pattern matching to identify suggestions that correspond to measurable changes, such as “reduce line speed by 10%” or “increase buffer size between stations 2 and 3.” Server computes specific numeric parameter values based on these patterns and on current apparatus settings. Server then constructs control commands in a protocol understood by the production apparatus or business apparatus. Server outputs control commands and transmits them through the network interface to the target apparatuses, which adjust their internal control loops in response.

### Step 15:

Terminal displays evaluation results and suggestions.

Terminal receives, as input, a display data package from the server that includes final achievement scores, work efficiency indices, emotion labels, and improvement suggestions, as well as visual style parameters for graphs and charts. Terminal transforms numerical values into graphical coordinates and selects color schemes according to emotion labels, such that positive emotions map to bright colors and negative emotions map to more subdued tones. Terminal draws bar charts comparing target and actual values, line charts showing historical trends, and text panels containing explanations and suggestions. Terminal outputs a rendered user interface that presents the complete evaluation and feedback to the user.

### Step 16:

User reviews feedback and selects follow-up actions.

User receives, as input, the displayed graphs, scores, emotion indicators, and suggestions on the terminal screen. User analyzes this information and selects follow-up actions, such as applying recommended process changes or scheduling additional training, by clicking buttons or checking options. Terminal processes these selections into a structured response and outputs this response to the server. Server receives the selected actions as input and updates an action tracking table, optionally creating reminders for future evaluation cycles.

### Step 17:

Server logs prompt sentences and model outputs for learning.

Server receives, as input, the prompt sentences and outputs involved in target generation, primary evaluation, secondary evaluation, and suggestion generation, together with the final achievement scores and any executed control commands. Server writes these into an AI audit log with fields such as timestamp, prompt text, model output, numeric scores, emotion labels, and applied actions. Server later processes these logs in batch mode to compute error metrics and detect systematic biases. Server outputs derived learning data that can be used to refine evaluation algorithms, adjust prompt sentence templates, or retrain models, thereby improving the technical performance of the system over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

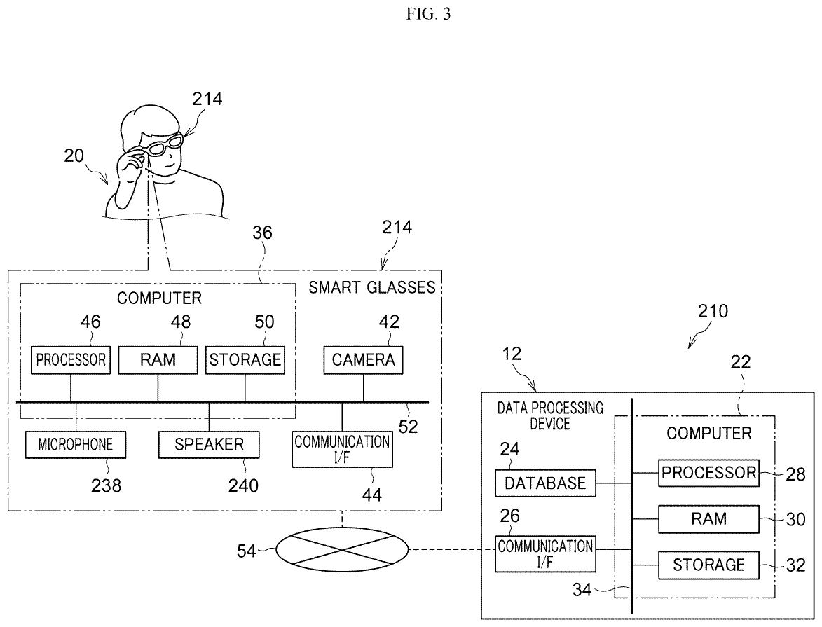

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

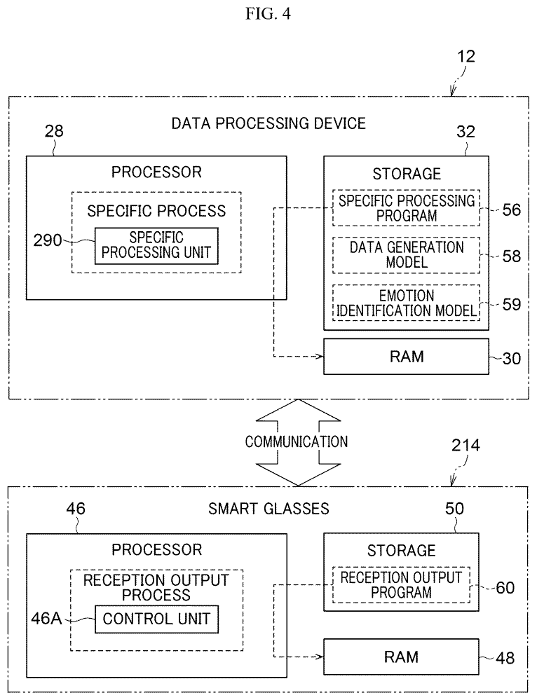

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

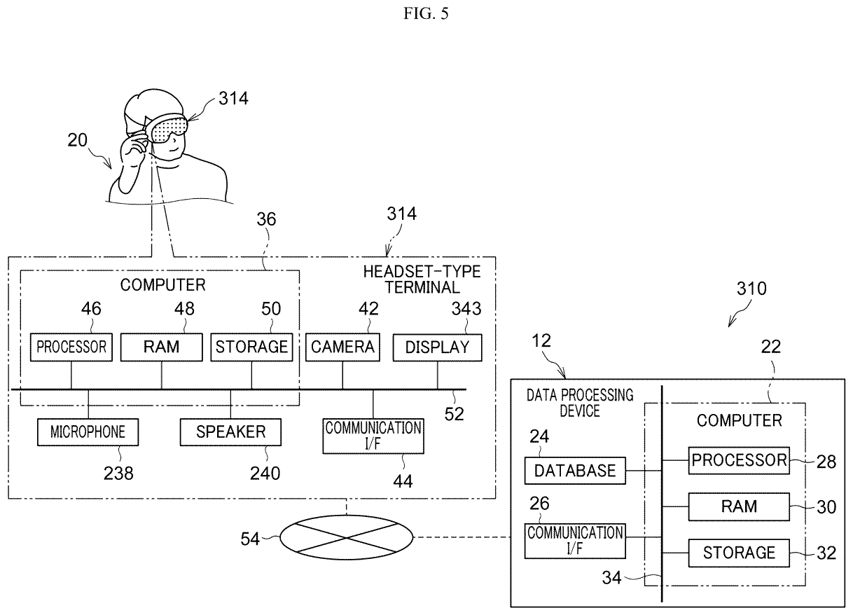

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

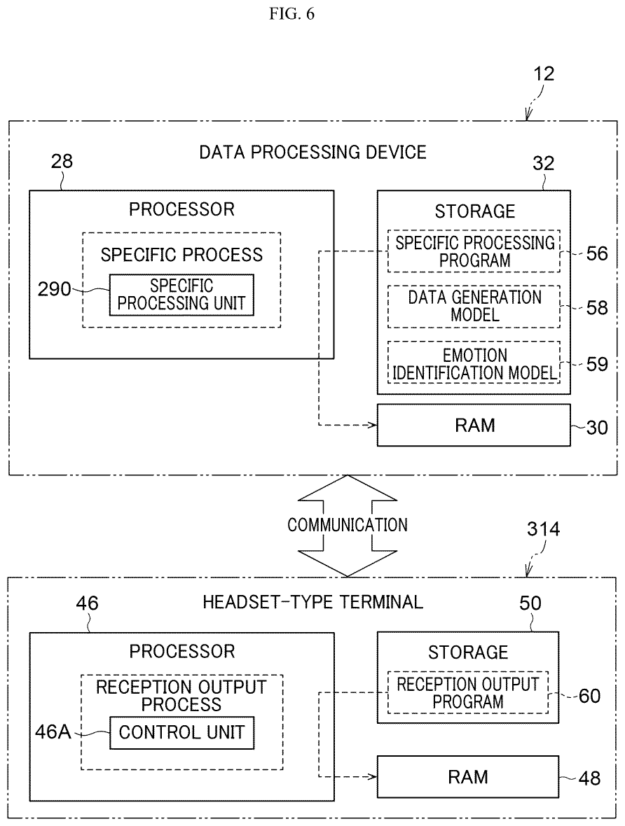

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

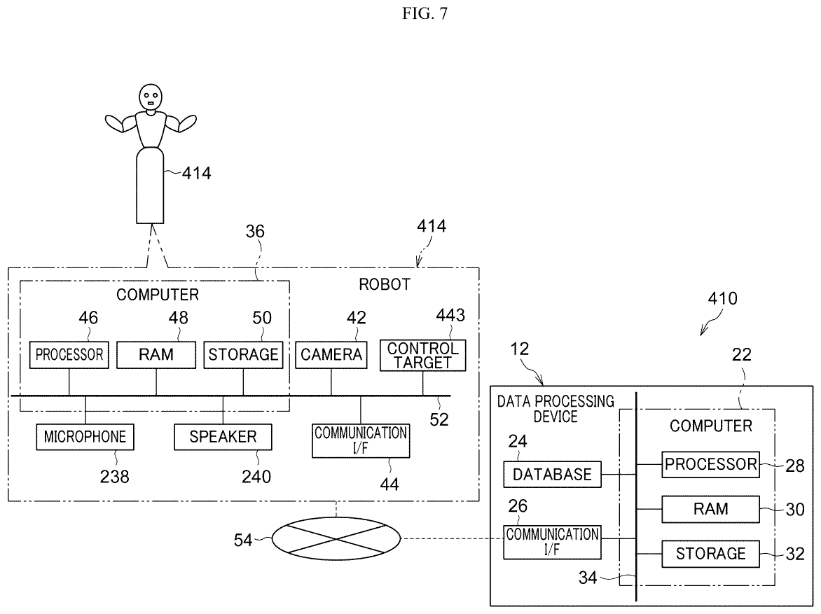

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

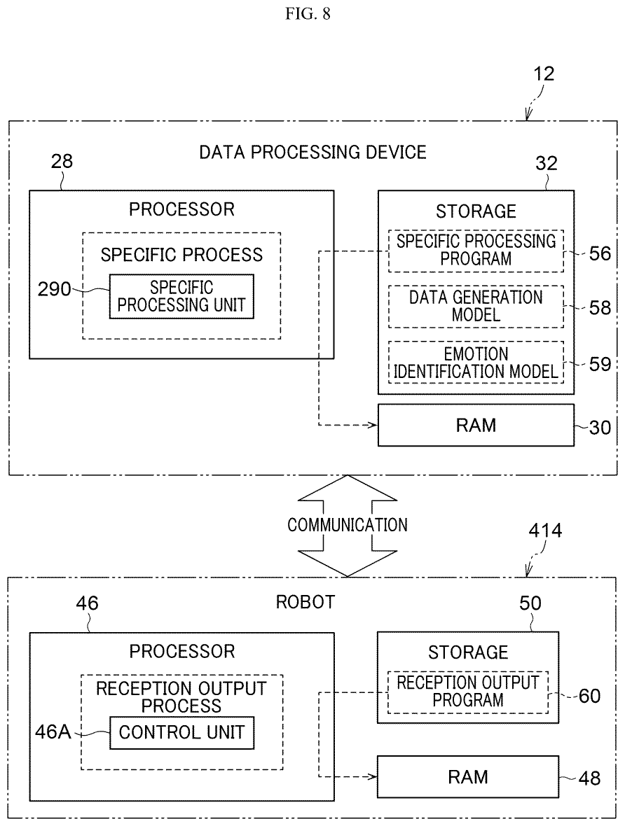

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

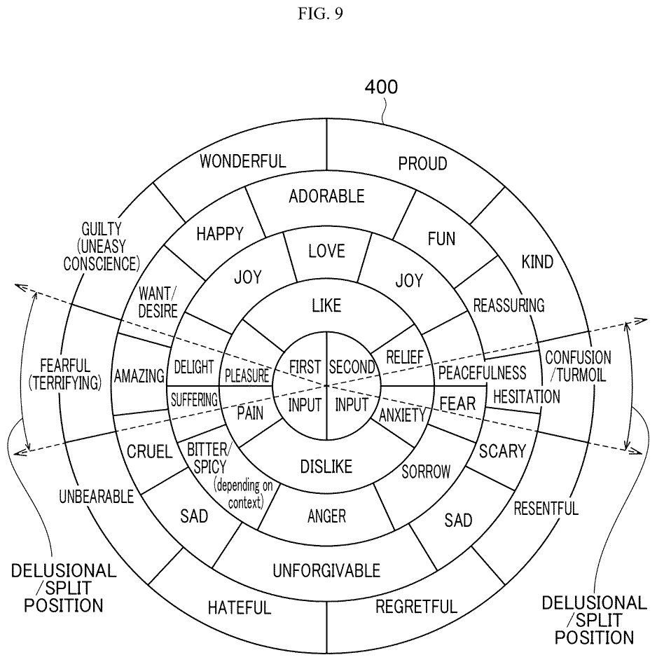

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

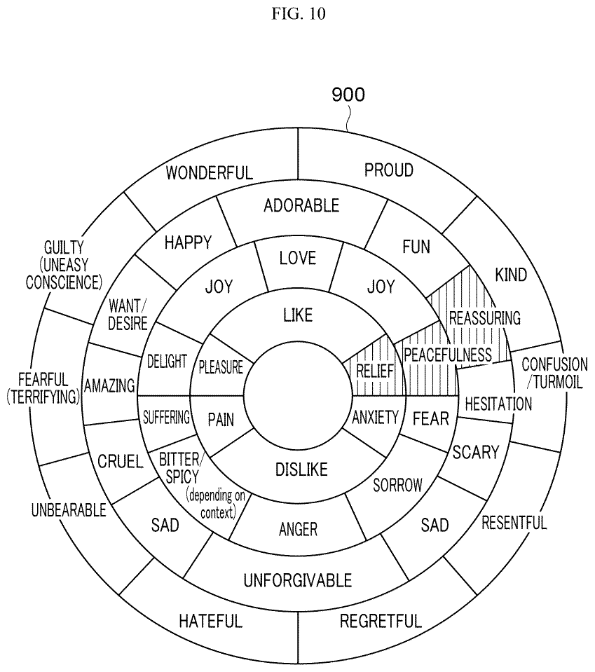

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire organizational theme information and organizational hierarchy information, obtain historical information including past goal-setting information and past performance information, extract feature information from the historical information, and calculate structured target values by using a machine learning model based on the feature information so as to automatically set a plurality of hierarchy-specific goals in accordance with the organizational theme information and the organizational hierarchy information,
generate a prompt sentence for input to a generative AI model based on the structured target values, the organizational theme information, and the organizational hierarchy information, and input the prompt sentence to the generative AI model so as to generate a goal sentence expressed in natural language,
store the organizational theme information, the organizational hierarchy information, the historical information, and the structured target values in an information storage device in association with the goal sentence expressed in natural language, and make stored information available for subsequent learning processing and evaluation processing,
generate a prompt sentence for input to the generative AI model based on achievement content acquired from an input device, and perform primary evaluation of a degree of achievement of the achievement content based on the prompt sentence,
acquire user voice information and user facial information, analyze the user voice information and the user facial information by using an emotion analysis engine to extract user emotion information, and perform achievement evaluation by complementing a primary evaluation result for the achievement content based on the user emotion information,
visually display an achievement evaluation result and the goal sentence expressed in natural language via an information display device so as to present the achievement evaluation result and the goal sentence in a manner that enables an individual to integrally grasp a goal and an achievement status, and
accumulate the achievement evaluation result and the user emotion information as historical information in the information storage device, and perform relearning or parameter adjustment for the machine learning model and the generative AI model by using accumulated information so as to continuously improve accuracy of future goal generation and future achievement evaluation.

### (Supplementary 2)

The system according to supplementary 1,
wherein the processor is configured to
generate a secondary-evaluation prompt sentence for input to the generative AI model based on a primary evaluation result of the achievement content and the user emotion information, input the secondary-evaluation prompt sentence to the generative AI model to perform secondary evaluation of the achievement content, and generate final achievement evaluation information by integrating the primary evaluation result and a secondary evaluation result.

### (Supplementary 3)

The system according to supplementary 1,
wherein the processor is configured to
generate visualization data including time-series information, achievement-rate information, and hierarchy-comparison information based on an achievement evaluation result and the goal sentence expressed in natural language, and cause the visualization data to be displayed as a graph or a chart on the information display device so that an individual can visually recognize the individual's own goal achievement status and a relative position in an organization.

### Application Example 1

### (Supplementary 1)

A system comprising a processor, a storage device, a communication interface, and a display device,
wherein the processor is configured to
receive, via the communication interface, department theme information and grade information from a terminal operated by a user, and to store the received department theme information and grade information in the storage device,
acquire, from the storage device, past production information and past quality information associated with a production line, preprocess the past production information and the past quality information by use of data processing software, generate feature data including at least the department theme information and the grade information, construct or update a regression model by use of statistical learning software based on the feature data and historical outcome data, and, by inputting the feature data into the regression model, predict a baseline production target value for each production line,
generate, based on the department theme information, the grade information, the past production information, the past quality information, and the predicted baseline production target value, a prompt sentence for input to a generative AI model, transmit the prompt sentence to the generative AI model via the communication interface, receive a response from the generative AI model, and, based on the response, correct or approve the baseline production target value to determine a final production target value and explanation information corresponding to the final production target value,
transmit, via the communication interface, the final production target value and the explanation information to the terminal so that the terminal displays the final production target value and the explanation information on the display device and accepts confirmation or approval input from the user, and receive, via the communication interface, the confirmation or approval input from the terminal and store an approval status in the storage device,
receive, via the communication interface from the terminal at an end of an evaluation period, achievement production information representing actual production results and comment information representing user comments, and store the achievement production information and the comment information in the storage device,
compare, by execution of program code, the achievement production information with the final production target value, calculate at least an achievement rate, and generate a primary achievement judgment result by use of rule-based logic or a machine learning model, generate, based on the primary achievement judgment result, the achievement production information, the comment information, and the final production target value, a second prompt sentence for input to the generative AI model, transmit the second prompt sentence to the generative AI model via the communication interface, receive a second response from the generative AI model, and, based on the second response, generate a textual evaluation regarding an achievement degree and improvement proposal information, and store the textual evaluation and the improvement proposal information in the storage device,
analyze, by use of an emotion analysis engine, voice data or image data of the user acquired via the terminal, estimate an emotion state of the user based on an analysis result, and correct at least one of the primary achievement judgment result and the textual evaluation based on the emotion state,
and generate, by use of visualization software, display data including at least the achievement rate, an achievement judgment result, the textual evaluation, and the improvement proposal information in a format including a graph or a chart, and transmit the display data to the terminal so that the terminal displays the display data on the display device.

### (Supplementary 2)

The system according to supplementary 1,
wherein the processor is configured to, based on the primary achievement judgment result, the achievement production information, and the final production target value, generate an additional prompt sentence for performing a secondary achievement judgment by the generative AI model, transmit the additional prompt sentence to the generative AI model via the communication interface, receive a third response from the generative AI model, and, based on the third response, generate a secondary achievement judgment result and detailed evaluation comment information, and transmit the detailed evaluation comment information to the terminal.

### (Supplementary 3)

The system according to supplementary 1,
wherein the processor is configured to, by use of the visualization software, generate comparison visualization data that visually compares the final production target value and the achievement production information in the form of at least one of a graph and a chart, transmit the comparison visualization data to the terminal via the communication interface, and enable the terminal to interactively display the comparison visualization data on the display device.

### Example 2

### (Supplementary 1)

A system comprising a processor,
wherein the processor is configured to
generate, by using a generative AI model, a prompt sentence for setting goal information for each grade in accordance with a management theme for each organizational unit, and generate the goal information for each grade based on the prompt sentence,
provide, by using an input/output control function of an information input/display device, an input screen configured by a description language and a script language executable by a browsing information processing function of a terminal device, accept an input operation of achievement content information by a user through the input screen, and acquire the achievement content information in a structured data format,
store, by using a storage information management device, the acquired achievement content information in association with identification information and time information,
read, by using an aggregation processing function, the stored achievement content information from the storage information management device, extract word information or numerical information from the achievement content information, compare the extracted information with preset evaluation standard information, and calculate a numerical primary achievement degree for the achievement content information,
generate, based on the achievement content information and the primary achievement degree, a prompt sentence to be input to the generative AI model, transmit the prompt sentence to the generative AI model, acquire evaluation information from the generative AI model, and perform a primary determination of an achievement degree based on the evaluation information,
analyze, by using an emotion analysis function, voice information or facial expression information of the user acquired from a voice acquisition device or an image acquisition device, recognize an emotional state of the user based on an analysis result, and supplement the primary determination of the achievement degree based on the emotional state so as to determine a final achievement degree by integrating the primary achievement degree and the evaluation information, and
convert, by using a display control function, the final achievement degree and explanation information obtained from the generative AI model into visual representation information, and present evaluation result information on an information display device.

### (Supplementary 2)

The system according to supplementary 1,
wherein the processor is configured to, prior to determination of the final achievement degree, generate, based on a primary determination result of the achievement degree and an analysis result of the emotion analysis function, a prompt sentence for performing a secondary determination of the achievement degree by using the generative AI model, input the prompt sentence to the generative AI model to acquire a secondary determination result, and correct the final achievement degree by integrating the primary determination result and the secondary determination result.

### (Supplementary 3)

The system according to supplementary 1,
wherein the processor is configured to aggregate the final achievement degree by period or by category by using a statistical processing function based on the final achievement degree and transition information thereof, generate visual representation data in a graph format or a chart format, and present the visual representation data by using the information display device so that an achievement degree distribution for an individual unit or a group unit is visually graspable.

### Application Example 2

### (Supplementary 1)

A system comprising a processor,
wherein the processor is configured to
generate a prompt sentence to be input to a generative AI model for setting target values for grades based on an organizational theme and past performance data, and input the prompt sentence and numerical data to the generative AI model to generate the target values for the grades,
record numerical information and text information of achievement data input by an individual, generate a prompt sentence for performing a primary evaluation of an achievement degree based on comparison between the achievement data and the target values and analysis of the text information, input the prompt sentence and the achievement data to the generative AI model to obtain a primary evaluation result of the achievement degree, and integrate the primary evaluation result into an achievement score through numerical calculation,
estimate an emotional state by using an emotion analysis engine with audio data and facial image data of the individual acquired from an audio acquisition device and an image acquisition device, execute an adjustment process for supplementing the evaluation of the achievement degree based on the achievement score and the emotional state, and calculate a final achievement score,
calculate a work efficiency index based on time-series data collected from a production process or a business process, generate a prompt sentence summarizing evaluation information including the final achievement score and the work efficiency index, and input the prompt sentence and related data to the generative AI model to generate improvement suggestion information,
convert a part of the improvement suggestion information corresponding to equipment control into a control parameter or a control command, and transmit the control parameter or the control command to a production apparatus or a business apparatus to optimize operation of the production apparatus or the business apparatus,
transmit the final achievement score, the work efficiency index, the emotional state, and the improvement suggestion information to an information display device, and generate display data for visually displaying, on the information display device, a graph or chart and text feedback representing the final achievement score, the work efficiency index, the emotional state, and the improvement suggestion information, and
associate and record the prompt sentences used in input/output processing with the generative AI model, output results of the generative AI model, and the final achievement score, and generate learning data for updating an evaluation algorithm or the prompt sentences based on the recorded information.

### (Supplementary 2)

The system according to supplementary 1,
wherein the processor is configured to generate a prompt sentence for performing a secondary evaluation of the achievement degree based on the primary evaluation result of the achievement degree and the emotional state estimated by the emotion analysis engine, input the prompt sentence and related data to the generative AI model to obtain a secondary evaluation result, and reflect the secondary evaluation result as the final achievement score.

### (Supplementary 3)

The system according to supplementary 1,
wherein the processor is configured to control a display format of the graph or chart on the information display device such that a color tone or an emphasis level is changed in accordance with the emotional state estimated by the emotion analysis engine, and visually display the achievement degree and the work efficiency together with the emotional state so that the individual can recognize the achievement degree and the work efficiency at a glance.

What is claimed is:

1. A system comprising:
circuitry configured to:
acquire category data and rank data, obtain historical performance records from a storage device, extract feature vectors from the historical performance records, and compute structured target values using a machine learning model applied to the feature vectors based on the category data and the rank data;
generate a first prompt sentence encoding the structured target values, the category data, and the rank data and input the first prompt sentence to a generative neural network model to produce a natural-language goal sentence;
store the category data, the rank data, the historical performance records, the structured target values, and the natural-language goal sentence in association in the storage device;
receive achievement content via a communication interface coupled to a packet-switched network, generate a second prompt sentence based on the achievement content, input the second prompt sentence to the generative neural network model, and perform a primary evaluation of a degree of achievement based on model output;
acquire audio information and image information from a terminal device, apply an emotion analysis model to the audio information and the image information to extract emotion data, and complement the primary evaluation using the emotion data to produce an achievement evaluation result; and
accumulate the achievement evaluation result and the emotion data as updated historical records and perform parameter adjustment of the machine learning model using the updated historical records.

2. The system of claim 1, wherein the circuitry is configured to construct the feature vectors by combining encoded category text, encoded rank category, and aggregated performance statistics from the historical performance records, and compute the structured target values including at least one target metric, a target change rate, and a time frame using a deep neural network comprising a text-encoding subnetwork and a dense prediction subnetwork.

3. The system of claim 2, wherein the text-encoding subnetwork comprises an embedding layer that converts tokenized category text into dense vectors and one or more transformer-based self-attention layers that compute contextualized text representations, and the dense prediction subnetwork comprises fully connected layers with nonlinear activation functions producing the structured target values.

4. The system of claim 3, wherein the circuitry is configured to train the deep neural network by computing a loss function between predicted target change rates and historically effective change rates from the historical performance records, updating model weights using an adaptive gradient optimization algorithm, and repeating weight updates until a convergence criterion is satisfied.

5. The system of claim 4, wherein the circuitry is configured to trigger retraining by constructing updated training batches from newly accumulated historical records and updating stored model parameters when accumulated records exceed a predetermined threshold count.

6. The system of claim 1, wherein the circuitry is configured to generate the first prompt sentence comprising an instruction section specifying a goal-generation task and a content section embedding the structured target values formatted as key-value pairs, and decode output tokens from the generative neural network model to extract the natural-language goal sentence.

7. The system of claim 6, wherein the circuitry is configured to validate the natural-language goal sentence for semantic consistency with the structured target values and store a validated goal sentence record linked to a session identifier in the storage device.

8. The system of claim 1, wherein the circuitry is configured to construct the second prompt sentence embedding the achievement content and the natural-language goal sentence and decode output tokens from the generative neural network model to produce a primary evaluation comprising a degree-of-achievement score and qualitative assessment labels.

9. The system of claim 8, wherein the circuitry is configured to perform a secondary evaluation by constructing an updated prompt sentence incorporating the primary evaluation result and additional contextual data from the storage device and inputting the updated prompt sentence to the generative neural network model to generate a refined evaluation result.

10. The system of claim 1, wherein the emotion analysis model processes the audio information to extract acoustic emotion features and processes the image information to extract facial expression features, and outputs emotion data comprising emotion category labels and intensity scores.

11. The system of claim 10, wherein the circuitry is configured to complement the primary evaluation by applying a weighting function to the degree-of-achievement score using the emotion intensity scores, producing a complemented evaluation value that adjusts for detected motivational or stress states reflected in the emotion data.

12. The system of claim 11, wherein the circuitry is configured to store the complemented evaluation value, the emotion category labels, and the intensity scores as linked records in the storage device, and use the stored records as additional training samples for the parameter adjustment.

13. The system of claim 1, wherein the circuitry is configured to generate visualization data comprising time-series information representing achievement values over successive evaluation periods, achievement-rate information representing ratios of achieved values to target values, and rank-comparison information enabling comparison of achievement across multiple rank levels.

14. The system of claim 13, wherein the circuitry is configured to transmit the visualization data and the natural-language goal sentence to the terminal device via the communication interface for integrated display presenting a goal, an achievement status, and temporal performance trends.

15. The system of claim 14, wherein the circuitry is configured to update the visualization data upon each new achievement evaluation result and push updated display data to the terminal device.

16. The system of claim 1, wherein the circuitry is configured to generate a confidence score for each item of the primary evaluation using the generative neural network model and suppress low-confidence evaluation items from the achievement evaluation result.

17. The system of claim 1, wherein the circuitry is configured to apply the parameter adjustment by constructing updated training batches from the accumulated historical records and performing iterative weight updates on both the machine learning model and the generative neural network model using mini-batch stochastic gradient descent.

18. A system comprising:
circuitry configured to:
acquire category data and rank data, extract feature vectors from historical performance records stored in a storage device, and compute structured target values comprising a target metric, a target change rate, and a time frame using a deep neural network comprising a text-encoding subnetwork applying transformer-based self-attention and a dense prediction subnetwork applying nonlinear activation functions;
construct a first prompt sentence embedding the structured target values and input the first prompt sentence to a generative neural network model to produce a natural-language goal sentence, and store the category data, the rank data, and the natural-language goal sentence in association in the storage device;
receive achievement content, construct a second prompt sentence embedding the achievement content and the natural-language goal sentence, input the second prompt sentence to the generative neural network model, and produce a primary evaluation comprising a degree-of-achievement score and qualitative assessment labels;
acquire audio information and image information from a terminal device via a communication interface coupled to a packet-switched network, apply an emotion analysis model to extract emotion category labels and intensity scores, and complement the primary evaluation using a weighting function applied to the degree-of-achievement score and the intensity scores to produce an achievement evaluation result;
generate visualization data comprising time-series information, achievement-rate information, and rank-comparison information and transmit the visualization data and the natural-language goal sentence to the terminal device for integrated display; and
accumulate the achievement evaluation result and the emotion data as updated historical records and perform parameter adjustment of the deep neural network and the generative neural network model using mini-batch weight updates.

19. The system of claim 18, wherein the circuitry is configured to perform a secondary evaluation by constructing an updated prompt sentence incorporating the primary evaluation result and additional contextual data and inputting the updated prompt sentence to the generative neural network model to produce a refined evaluation result, and to store the refined evaluation result linked to the achievement evaluation result in the storage device.

20. A method comprising:
acquiring category data and rank data, obtaining historical performance records from a storage device, extracting feature vectors from the historical performance records, and computing structured target values using a machine learning model applied to the feature vectors based on the category data and the rank data;
generating a first prompt sentence encoding the structured target values, the category data, and the rank data and inputting the first prompt sentence to a generative neural network model to produce a natural-language goal sentence;
receiving achievement content via a communication interface coupled to a packet-switched network, generating a second prompt sentence based on the achievement content, inputting the second prompt sentence to the generative neural network model, and performing a primary evaluation of a degree of achievement based on model output;
acquiring audio information and image information from a terminal device, applying an emotion analysis model to the audio information and the image information to extract emotion data, and complementing the primary evaluation using the emotion data to produce an achievement evaluation result; and
accumulating the achievement evaluation result and the emotion data as updated historical records and performing parameter adjustment of the machine learning model using the updated historical records.
